(19) United States
(12) Patent Application Publication
(10) Pub. No.: US 2008/0138600 A1
(43) Pub. Date: Jun. 12, 2008

(54) Soluble Metal Oxides and Metal Oxide Solutions

(75) Inventors: Patrick Desmond Cunningham, Spiddal (IE); Patsy Clancy-Cunningham, Spiddal (IE); James McManus, Railway View (IE)

Correspondence Address: THE WEBB LAW FIRM, P.C., 700 KOPPERS BUILDING, 436 SEVENTH AVENUE, PITTSBURGH, PA, 15219, US

(73) Assignee: NATIONAL UNIVERSITY OF IRELAND, GALWAY, Galway (IE)

(21) Appl. No.: 11/925,095

(22) Filed: Oct. 26, 2007

Related U.S. Application Data
(63) Continuation-in-part of application No. 10/580,097, filed on May 19, 2006.

(51) Int. Cl. C07F 7/28; B32B 3/26; C09D 4/00; C07F 7/22

(52) U.S. Cl. 428/304.4; 556/40; 106/287.19; 502/152

(57) ABSTRACT

The invention relates to soluble metal oxides and mixed metal oxides and to solutions comprising metal oxides and mixed metal oxides. The invention further relates to a process for preparing a soluble metal oxide and a soluble mixed metal oxide and additionally relates to a process for modifying the solubility of a soluble metal oxide. The metal oxides, mixed metal oxides and solutions thereof have a number of applications and in particular are suitable for use as catalysts and also as precursors for the formation of metal oxide coatings. The present invention is also suitable for coating medical devices, and can be used for coating drug cocktails to produce sustained release tablets. Similarly, the coatings may be used for the sustained release of pesticides, insecticides, dyes and fragrances. Further uses include the application of the present invention to coat the moving parts of engines and machinery. Furthermore the present invention has application as use as spacer layers in Metal Enhanced Fluorophores (sensing platforms).

### RELATED APPLICATIONS

This application is a continuation in part of U.S. application Ser. No. 10/580,097 filed May 19, 2006.

### BACKGROUND TO THE INVENTION

The present invention relates to a soluble metal oxide and a soluble mixed or doped metal oxide. The invention also relates to a solution comprising a metal oxide and to a solution comprising a mixed metal oxide. The invention further relates to a process for preparing a soluble metal oxide and to a process for preparing a soluble mixed or doped metal oxide, and still further relates to a process for modifying the solubility of a soluble metal oxide.

In the specification the term “metal oxide” refers to a chemical compound in which only oxygen is combined with a metal. In the specification the term “particle” refers to a crystalline structure having an average dimension of 100 Å or less.

In the specification the term “coating” refers to coatings of various thickness applied to a substrate, from thin film-like coatings to thick coatings.

Metal oxides and in particular tin oxide have an important role in many coating applications: (a) Domestic glassware and bottles contain a thin coating of tin oxide to greatly enhance impact resistance. Thicker coatings confer iridescent appearances that provide attractive finishes to glass objects. (b) Thin coatings of tin oxide on window glass serve to reflect indoor heat inwards in winter time and reduce solar heating in summer time. (c) Conducting tin oxide films have a vital role as transparent electrodes in the construction of many important devices including light harvesting solar cells, electrochromic cells and liquid crystal displays. Conducting tin oxide films can also be applied to car and aircraft windscreens. (d) Thin coatings of tin oxide are used to improve bonding characteristics of surfaces. A coating of tin oxide on alumina can be used to enhance bonding for high-alumina dental ceramics. (e) Tin oxide films can be used in many applications and industries as gas sensors. (f) Metal oxide coatings reduce surface friction and thus have applications for moving parts in engines, hip replacements and stents. (g) Metal oxide coatings also have important roles in other applications such as use in the production of industrial catalysts. In such applications, the catalyst fabrication process and pre-history is vitally important for catalytic performance.

Current methods for the preparation of metal oxide films and coatings from metal oxides and other metal compounds include: a) Vacuum techniques such as Chemical Vapour Deposition (CVD), electron-beam evaporation and reactive sputtering. Chemical Vapour Deposition is the growth of thin solid films as the result of thermo-chemical vapour-phase reactions. This technique requires however specialised equipment such as a vacuum chamber and the use of suitable volatile metal precursors. The size of the object to be coated is limited to the size of the vacuum chamber. Furthermore, there is an associated high cost of maintaining the high vacuum required and the precise heating control to vaporise the precursor material. b) Pyrolysis/hydrolysis of the vapour of a suitable metal compound on a hot substrate surface. In the case of large-scale industrial tin oxide coating of bottles, this technique is adopted and requires the use of tin tetrachloride and butylin trichloride as precursors. Tin tetrachloride is a highly corrosive caustic liquid which is both toxic and environmentally hazardous. Both compounds produce corrosive hydrogen chloride gas during the hydrolysis and subsequent formation of tin oxide films. c) Evaporation of a precursor solution, sol or solvent dispersion from the surface of the substrate. Precursor solutions, sols and dispersions fall broadly into two types. (i) A solution containing a metal compound (usually an alkoxide) can be applied to a substrate and can then undergo hydrolysis to yield the metal oxide. The desired oxide is only obtained after total hydrolysis of the metal alkoxide on the substrate surface to give a hydroxide or hydrous oxide after which heating to very high temperatures in the region of 500° C. yields the oxide. This is a slow process and demands precise chemical control of the precursor solution. Additionally the metal oxide is not available for modification in downstream processes such as film formation. It will be appreciated that this process is necessary to yield the oxide as the solutions containing the metal compounds do not at any stage contain a metal oxide but merely a precursor to the metal oxide. (ii) A solvent containing a dispersed metal oxide in the form of a dispersion colloid or a sol. A sol is defined as a colloidal solution consisting of a suitable dispersion medium and a colloidal substance which is distributed throughout the dispersion medium. Dispersants must be added to improve the dispersibility of the oxides.

Application of the solutions, sols, colloids and dispersions may be by a range of techniques which includes spin coating, curtain-flow coating, meniscus coating, dip coating, roll-on coating or aerosol coating. The method of coating depends on a number of factors, including the physical nature and stability of the solution, sol, colloid and dispersion and both the size and shape of the surface to be coated. An application technique such as spin coating is suited to small-scale coating whereas techniques such as curtain-flow and aerosol coating are suitable for large-scale coating. Aerosol coating is particularly suited to the coating of irregular shaped objects.

The coating methods of (c) are preferable to those described in both (a) and (b) in that they are considerably cheaper and easier to apply. Furthermore they are more suited to the coating of large and irregular shaped objects. The techniques outlined in (c) work best when the material to be fabricated into the film is in solution. A metal oxide therefore in solution would prove particularly advantageous with these techniques. Furthermore a metal oxide soluble in a range of solvents would provide increased versatility within these applications.

PCT Publication No. WO 03/027191 discloses a curable liquid resin composition comprising a metal oxide, an organic compound, a compound having two or more polymerizable unsaturated groups in the molecule, a specific alkylene glycol organic solvent and a polymerization initiator. The metal oxides are dispersed in the liquid resin compositions.

European Patent Publication No. 1 243 631 discloses an organic solvent based dispersion of conductive powder and conductive coating material comprising conductive tin oxide particles coated with an organic metal coupling agent on the surface of the tin oxide particles and a dispersant in the form of a salt to achieve dispersibility.

U.S. Pat. No. 6,399,688 discloses a coating composition comprising a metal oxide a hydrophilic binder, a colloidal silica and a solvent.

The disadvantage of the above compositions is that dispersants are required which are difficult or impossible to remove during film fabrication. In fact it is this feature of dispersants that makes them undesirable in many instances. Dispersing agents are generally unfavourable in that they cannot be removed during fabrication of the desired film. Furthermore, the presence of dispersants can present difficulties when attempting to modify the tin oxide particles in the dispersion. For example, the dispersants can hinder the addition of metal dopants or desired surface groups to the tin oxide particles.

European Patent Publication no. 1 152 040 discloses an aqueous coating solution for forming a transparent conductive film, a method for producing a transparent conductive tin oxide film and a transparent conductive tin oxide film. The coating solution may be prepared from tin oxide and is prepared by adding hydrous tin oxide to distilled water and bringing the pH to a value of at least 10. The disadvantage of this type of solution is that it is corrosive due to the high pH involved and would therefore be unsuitable for certain applications. Additionally as the solution is predominantly an aqueous solution and it could not be used in any applications requiring organic solvents. Furthermore, it is not possible to extract the soluble metal oxide from this solution and store it in this state.

Thus there is need for a metal oxide solution suitable for use in a number of applications. There is further a need for a soluble metal oxide which can be dissolved in a range of solvents.

### OBJECT OF THE INVENTION

According to the invention there is provided a soluble metal oxide comprising: one or more metal oxide crystallite particles; each crystallite particle comprising a plurality of metal and oxygen moieties; an inner organic binding group attached to at least one metal moiety; and an outer organic binding group attached to at least one inner organic binding group.

The advantage of providing a soluble metal oxide is that it can either be dissolved in a solvent to provide a solution or stored in this form as a powder and redissolved in an appropriate solvent to form a solution. The soluble metal oxide is thus extremely flexible, as it can be used to provide a number of solutions which can be adapted to any application. Additionally, the soluble metal oxides form true solutions therefore obviating the need for undesirable additives such as dispersants. The process for preparing the said soluble metal oxides is a simple, effective and economical process. In particular, there is no requirement for chemical additives such as dispersants to achieve solubility. Furthermore, there is no requirement for exposure to vigorous dissolution methods such as sonication to achieve solubility.

The metal oxide crystallites in solution are remarkably chemically active such that considerable modification of the crystallites in solution, to meet specific functional demands, is easily achievable without loss of solubility. Furthermore the surfaces of a metal oxide when dissolved in a solution are more chemically active than when the metal oxide is dispersed in a dispersion or resin or in the form of a gel. Additionally, due to the enhanced surface activity and chemical reactivity of the metal oxides in solution they can be usefully employed to produce doped and conducting metal oxide films for the electronics industry and gas sensor devices, for a range of applications.

The process of the present invention can also be considered to be a process for preparing a soluble metal oxide comprising: adding an amount of insoluble hydrous metal oxide particles having a plurality of metal and oxygen moieties, to carboxylic acid to form a suspension of the metal oxide in the carboxylic acid, a sufficient amount of carboxylic acid being provided so that, upon heating the suspension to an appropriate temperature, sufficient carboxylate groups attach to the surface of the particles so as to surface modify the metal oxide crystallite particles by attachment of the carboxylate groups and/or any molecule hydrogen bonded to the carboxylate groups to solubilse the metal oxide crystal particles in said acid; and heating the suspension to an appropriate temperature.

Preferably, each crystallite particle further comprises at least one surface hydroxyl group.

Further preferably each inner organic binding group is attached to a metal moiety by a covalent bond; and outer organic binding groups are attached to at least one of inner organic binding groups or surface hydroxyl groups by a hydrogen bonding.

The advantage of having inner and outer organic binding groups is that they allow increased solubility of the metal oxide particles in the organic solvent. The inner organic binding groups directly attached to the metal oxide generally do not give rise to solubility. They are however required since their presence is absolutely essential for the attachment of the outer organic binding group in sufficient quantity to the metal oxides. The outer organic binding groups control solubility of the metal oxide.

In some cases however depending on the type of organic group, it has been found that the metal oxides are soluble with the presence of inner organic binding groups only. This has found to be particularly true for fluoroacetate groups as organic binding groups and may be due to the presence of exposed fluorine atoms.

In one embodiment of the invention, the soluble metal oxide is of the general formula: [{[MOm]n(OH)p}Xq/Yr]/(H2O)s wherein: M represents a metal moiety; O represents an oxygen moiety; m is a variable dependent on the oxidation state of the metal moiety (M) and is in the region of between 1 and 3; n represents the number of metal oxides in the crystallite particle; OH represents an hydroxyl group; X represents an inner organic binding group; Y represents an outer organic binding group; H2O represents hydrogen bonded water; p, q, r and s represent variables dependent in particular on the number of metal oxides in the crystallite particle (n), and reaction conditions.

Preferably X represents the inner organic binding group of the general formula:

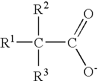

Wherein: R1=an organic group, a halo-organic group, a hydrogen or a halogen; R2=an organic group, a halo-organic group, a hydrogen or a halogen; and R3=an organic group, a halo-organic group, a hydrogen or a halogen.

Further preferably, R1 represents a straight-chain, branched chain or cyclic organic group with up to 20 carbons (preferably up to 5 carbons), a straight-chain, branched-chain, or cyclic halo-organic group with up to 20 carbons (preferably up to 5 carbons) and up to 41 halogen atoms 41 halogen atoms (preferably up to 3 halogen atoms), a hydrogen or a halogen; R2 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; and R3 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen.

Preferably Y represents the outer organic binding group of the general formula:

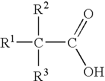

Wherein: R1=an organic group, a halo-organic group, a hydrogen or a halogen; R2=an organic group, a halo-organic group, a hydrogen or a halogen; and R3=an organic group, a halo-organic group, a hydrogen or a halogen.

Further preferably, R1 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; R2 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; and R3 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen.

In this specification, an organic group is exemplified by an alkyl group and a halo-organic group is exemplified by a halo-alkyl group. An alkyl group preferably has from 1 to 10 carbon atoms and most preferably from 1 to 6 carbon atoms. Halo includes chloro, fluoro, bromo or iodo and is exemplified herein by fluoro. Suitably, in the organic binding groups and the organic acid R1, R2 and R3 represent one of:

R1=R2=R3=H

R1=R2=H; R3=(CH)nCH3(n=0,1,2,3,4,5)

R1=H; R2=R3=CH3

R1=H; R2=CH3; R3=CH2CH3

R1=R2=R3=CH3

R1=R2=R3=F

Desirably, the organic acid heretofore referred to may be a C1-C20 aliphatic (cyclic or acyclic) or a C6-C20 aromatic organic acid optionally substituted one or more times with one or more halogen atoms or optionally substituted one or more times with alkoxy groups or optionally substituted one or more times with hydroxyl groups. The organic acid may be one of mono-, di-, or tricarboxylic acids.

The organic acid may be at least one of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dinethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acids.

Wherein the mono- and mixed haloproprionic acids include the categories listed below; (i) The monosubstituted 2-halopropionic acids of the type CH3CHXCOOH, X═F, Cl, Br, I. (ii) The monosubstituted 3-halopropionic acids of the type CH2XCH2COOH, X═F, Cl, Br, I. (iii) The disubstituted 2,2-dihalopropionic acids of the type CH3CX2COOH, X═F, Cl, Br, I. (iv) The disubstituted mixed 2,2-dihalopropionic acids of the type CH3CXYCOOH, X═F, and Y═Cl, Br, I or vice versa. (v) The disubstituted 2,3-dihalopropionic acids of the type CH2X CHXCOOH, X═F, Cl, Br, I. and the corresponding mixed 2,3 dihalopropionic acids thereof. (vi) The disubstituted 3,3-dihalopropionic acids of the type CHX2CH2COOH, X═F, Cl, Br, I. and the corresponding mixed 2,3 dihalopropionic acids thereof. (vii) The trisubstituted 2,2,3-trihalopropionic acids of the type CH2X CX2COOH, X═F, Cl, Br, I and the possible mixed 2,2,3-trihalopropionic acids thereof. (viii) The trisubstituted 2,3,3-trihalopropionic acids of the type CHX2CHXCOOH, X═F, Cl, Br, I and the possible mixed 2,3,3-trihalopropionic acids thereof. (ix) The trisubstituted 3,3,3-trihalopropionic acids of the type CX3CH2COOH, X═F, Cl, Br, I and the possible mixed 3,3,3-trihalopropionic acids thereof. (x) The tetrahalo substituted propionic acids of the 2,2,3,3 type and the 2,3,3,3 type with respective general formulae CHX2CX2COOH and CX3CHXCOOH; X═F, Cl, Br, I and the possible mixed tetrahalopropionic acids thereof. (xi) The pentahalo-substituted propionic acids of the type CX3CX2COOH, X═F, Cl, Br, I.

The organic acid may be at least one of acetic, dichloroacetic, trifluoracetic, cyanoacetic, methoxyacetic, propanoic, tartaric, and citric acid.

Ideally each metal oxide crystallite particle is a nanocrystallite particle having an average particle size in the range of between 5 and 100 Å. This is advantageous in that as the particle size of the metal oxide particles are very small, the surface area is very large resulting in enhanced reactivity with the organic binding groups.

Preferably the metal moiety is selected from the group comprising one of tin and titanium.

According to the invention, there is further provided a soluble mixed or doped metal oxide comprising: a soluble metal oxide wherein each crystallite particle further comprises: at least one metal ion attached to each crystallite particle.

The amount of metal ions which attach to and become embodied in the crystallite particle is highly variable and depends on a number of factors, including the solvent within the solution during preparation of the mixed metal oxide, the type of metal ion, the compatibility between the metal ion and the solvent or with the metal moiety and the reaction conditions. It will be appreciated that modification of each of these factors will result in an optimum quantity of each metal ion.

Preferably, each inner organic binding group is attached to either a metal moiety or to both a metal moiety and to a metal ion; outer organic binding groups are attached to at least one of a metal ion, an inner organic binding group, or a surface hydroxyl group; and wherein the metal ions are attached to any combination of the following: an oxygen moiety, an hydroxyl group; an inner organic binding group; and an outer organic binding group.

Further preferably, each inner organic binding group is attached to a metal moiety by a covalent bond, and to a metal ion by either a covalent bond or a donor bond; outer organic bindings group are attached to inner organic binding groups by a hydrogen bond, to surface hydroxyl groups by a hydrogen bond, or to a metal ion by either a covalent bond or a donor bond; and each metal ion is attached to an oxygen moiety by a covalent bond, to a hydroxyl group by either a donor bond or a covalent bond, to an inner organic binding group by either a covalent or a donor bond, and to an outer organic binding group by either a covalent or a donor bond.

In another embodiment of the invention, the soluble mixed metal oxide is of the general formula: [{[MOm]n(OH)ₚ}M′c XqYr]/(H2O)s M represents a metal moiety; O represents an oxygen moiety; m is a variable dependent on the oxidation state of the metal moiety (M) and is in the region of between 1 and 3; n represents the number of metal oxides in the crystallite particle; OH represents an hydroxyl group; M′ represents the dopant metal; c represents the number of dopant metal particles in the soluble metal oxide; X represents an inner organic binding group; Y represents an outer organic binding group; H2O represents hydrogen bonded water; p, q, r and s represent variables dependent in particular on the number of metal oxides in the crystallite particle (n), and reaction conditions.

Ideally the dopant metal (M′) is one selected from the group comprising of tin, indium, antimony, zinc, titanium, vanadium, chromium, manganese, iron, ruthenium, osmium, tungsten, cobalt, nickel, zirconium, molybdenum, palladium, iridium and magnesium.

The resultant mixed metal oxides can be any of tin/tin oxide, tin/indium oxide, tin/antimony oxide, tin/zinc oxide, tin/titanium oxide, tin/vanadium oxide, tin/chromium oxide, tin/manganese oxide, tin/iron oxide, tin/ruthenium oxide, tin/osmium oxide, tin/tungsten oxide, tin/cobalt oxide, tin/nickel oxide, tin/zirconium oxide, tin/molybdenum oxide, tin/palladium oxide, tin/iridium oxide, tin/magnesium oxide, titanium/titanium oxide, titanium/antimony oxide, titanium/zinc oxide, titanium/tin oxide, titanium/vanadium oxide, titanium/chromium oxide, titanium/manganese oxide, titanium/iron oxide, titanium/ruthenium oxide, titanium/osmium oxide, titanium/tungsten oxide, titanium/cobalt oxide, titanium/nickel oxide, titanium/zirconium oxide, titanium/molybdenum oxide, titanium/palladium oxide, titanium/iridium oxide, titanium/magnesium oxide.

Preferably X represents the inner organic binding group of the general formula:

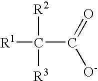

Wherein: R1=an organic group, a halo-organic group, a hydrogen or a halogen; R2=an organic group, a halo-organic group, a hydrogen or a halogen; and R3=an organic group, a halo-organic group, a hydrogen or a halogen.

Further preferably, R1 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; R2 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; and R3 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen.

Preferably Y represents the outer organic binding group of the general formula.

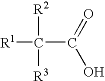

Wherein: R1=an organic group, a halo-organic group, a hydrogen or a halogen; R2=an organic group, a halo-organic group, a hydrogen or a halogen; and R3=an organic group, a halo-organic group, a hydrogen or a halogen.

Further preferably, R1 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; R2 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; and R3 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen;

Desirably, the organic acid heretofore referred to may be a C1-C20 aliphatic (cyclic or acyclic) or a C6-C20 aromatic organic acid optionally substituted one or more times with one or more halogen atoms or optionally substituted one or more times with alkoxy groups or optionally substituted one or more times with hydroxyl groups. The organic acid may be one of mono-, di-, or tricarboxylic acids.

The organic acid may be at least one of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acids.

The organic acid may be at least one of acetic, dichloroacetic, trifluoracetic, cyanoacetic, methoxyacetic, propanoic, tartaric, and citric acid.

Ideally each crystallite particle is a nanocrystallite particle having an average particle size in the range of between 5 and 100 Å.

Preferably the metal moiety is selected from the group comprising one of tin, and titanium.

### SUMMARY OF THE INVENTION

According to the invention there is still further provided a process for preparing a metal oxide solution comprising: adding an amount of insoluble hydrous metal oxide to an amount of organic acid to provide a metal oxide suspension; heating the suspension until the suspension forms a solution; wherein the insoluble hydrous metal oxide is added to a sufficient amount of organic acid to allow a solution to be formed during heating.

According to the invention there is further provided a process for preparing a soluble metal oxide comprising: preparing a metal oxide solution; and removing the organic acid from the solution to provide the soluble metal oxide. This process for preparing metal oxide solutions and soluble metal oxides is a fast, inexpensive and environmentally friendly process. The advantage of the metal oxide being hydrous is that there are water molecules and hydroxyl groups surrounding the metal oxide particles, which can assist in the binding of acetate moieties to the surface.

The acid used must be an organic acid as it has been found that other types of acids do not interact in the same way with the metal oxides. For example mineral acids such as nitric acid are not suitable because the oxide breaks down and an oxide solution is not formed. Additionally the advantage of using the organic acids is that their removal at elevated temperature during formation of metal oxide films does not leave groups that would introduce undesirable impurities into the metal oxide.

The advantage of heating the suspension is that it facilitates a fast exchange reaction between the hydroxyl groups of the hydrous metal oxide and the organic binding groups of the acid so as to bond a sufficient percentage of organic binding groups to the metal oxide particles.

Removal of the organic acid from the solution is generally carried out at a reduced pressure and preferably less than 25 mm.Hg in that this reduced pressure facilitates the fast removal of acid without any significant loss of organic binding groups.

Preferably, the acid is of the general formula:

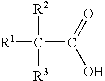

Wherein: R1=an organic group, a halo-organic group, a hydrogen or a halogen; R2=an organic group, a halo-organic group, a hydrogen or a halogen; and R3=an organic group, a halo-organic group, a hydrogen or a halogen.

Further preferably, R1 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; R2 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen; and R3 represents a straight-chain, branched-chain or cyclic organic group with up to 20 carbons20 carbons (preferably up to 5 carbons), a straight-chain, branched-chain, or cyclic halo-organic group with up to 20 carbons20 carbons (preferably up to 5 carbons) and up to 41 halogen atoms41 halogen atoms (preferably up to 3 halogen atoms), a hydrogen or a halogen.

Desirably, the organic acid heretofore referred to may be a C1-C20 aliphatic (cyclic or acyclic) or a C6-C20 aromatic organic acid optionally substituted one or more times with one or more halogen atoms or optionally substituted one or more times with alkoxy groups or optionally substituted one or more times with hydroxyl groups. The organic acid may be one of mono-, di-, or tricarboxylic acids.

The organic acid may be at least one of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acids.

The organic acid may be at least one of acetic, dichloroacetic, trifluoracetic, cyanoacetic, methoxyacetic, propanoic, tartaric, and citric acid.

In one embodiment of the invention there is provided a process for preparing a mixed metal oxide solution comprising: preparing a metal oxide solution; adding a metal to the solution; and filtering the solution.

In another embodiment of the invention there is provided a process for preparing a soluble mixed metal oxide comprising: preparing a mixed metal oxide solution; and removing the organic acid to provide the soluble mixed metal oxide.

In a further embodiment of the invention, there is provided a process for preparing a mixed metal oxide solution comprising: preparing a soluble metal oxide; dissolving the metal oxide in a solvent to provide a solution; adding a metal to the solution; and filtering the solution.

Preferably, prior to filtering, the solution is heated. Further preferably the metal is added in powder form.

Preferably, the solvent is selected from the group comprising one of tetrahydrofuran, dimethylformamide, dimethyl sulphoxide, ethyl acetate, amyl acetate, pyridine, water, acetophenone, isophorone, an alcohol having the general formula:

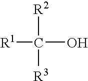

Where R1, R2 and R3 represent one of: R1=R2=R3=H; R1=R2=H; R3=(CH)nCH3 (n=0, 1, 2, 3, 4, 5); R1=H; R2=R3=CH3; R1=H; R2=CH3; R3=CH2CH3; R1=R2=R3=CH3; an ether having the general formula R1=O—R2; Where R1 and R2 represent one of: R1=R2=CH2CH3; R1=CH3; R2=CH2CH3; R1=R2=(CH2)3CH3; and A ketone having the general formula R1COR2; Where R1=(CH2)nCH3 (n=0, 1, 2, 3, 4, 5); R2=(CH2)nCH3 (n=0, 1, 2, 3, 4, 5) and R1=R2 or R1≠R2.

A diketone having the general formula R1COCH2COR2; Where R1=(CH2)nCH3 (n=0, 1, 2, 3, 4, 5); R2=(CH2)nCH3 (n=0, 1, 2, 3, 4, 5); and R1=R2 or R1≠R2.

A C5-C12 cyclic ketone optionally substituted with methyl groups and/or optionally unsaturated selected from the group of cyclopentanone, 2-methylcyclopentanone, 3-methylcyclopentanone, cyclohexanone, 2-methylcyclohexanone, 3-methylcyclohexanone, 4-methylcyclohexanone, 3,3,5-trimethylcyclohexanone, 3,5,5-trimethyl-2-cyclohexene-1-one (Isophorone), 2-cyclohexene-1-one, 3-methyl-2-cyclohexene-1-one, 3-methyl-5-heptene-2-one.

In a still further embodiment of the invention, there is provided a process for preparing a soluble mixed metal oxide comprising: preparing a mixed metal oxide solution; and removing the solvent to provide the soluble mixed metal oxide.

Both the soluble metal oxides and soluble mixed metal oxides can be recovered from solution without loss of solubility. The recovered oxides are in the form of powders, which have excellent long-term stability and thus can be conveniently stored for future applications. The soluble metal oxides and mixed metal oxides can be utilised as heterogeneous or homogeneous catalysts. Furthermore, solutions of the soluble metal oxides and mixed metal oxides are extremely valuable precursors for the fabrication of metal oxide and doped metal oxide films for use in particular in the electronics industry, monoliths, castings and catalysts.

The resultant oxide powders can be dissolved in any appropriate solvent. In this case solubility in the organic solvents is remarkably high.

According to the invention, there is still further provided a process for preparing a soluble metal oxide suitable for dissolving in a target organic solvent comprising: selecting the target solvent; determining an organic binding group which, when attached to an insoluble metal oxide would allow the metal oxide to dissolve in the target solvent; selecting an organic acid suitable for providing the organic binding group; and preparing the soluble metal oxide using the selected organic acid.

According to the invention there is further provided a metal oxide solution prepared by; adding an amount of insoluble hydrous metal oxide to an amount of organic acid to provide a metal oxide suspension; heating the suspension until the suspension forms a solution; wherein the insoluble hydrous metal oxide is added to a sufficient amount of organic acid to allow a solution to be formed during heating.

According to the invention there is still further provided a mixed metal oxide solution comprising a soluble mixed metal oxide and a solvent comprising one or more of tetrahydrofuran, dimethylformamide, dimethyl sulphoxide, ethyl acetate, amyl acetate, pyridine, water, acetophenone, isophorone, an alcohol having the general formula:

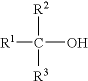

Where R1, R2 and R3 represent one of: R1=R2=R3=H; R1=R2=H; R3=(CH)nCH3 (n=0, 1, 2, 3, 4, 5); R1=H; R2=R3=CH3; R1=H; R2=CH3; R3=CH2CH3; R1=R2=R3=CH3.

An ether having the general formula R1=O—R2; Where R1 and R2 represent one of: R1=R2=CH2CH3; R1=CH3; R2=CH2CH3; R1=R2=(CH2)₃CH3; and A ketone having the general formula R1COR2.

Where R1=(CH2)nCH3 (n=0, 1, 2, 3, 4, 5); R2=(CH2)nCH3 (n=0, 1, 2, 3, 4, 5) and R1=R2 or R1≠R2.

A diketone having the general formula R1COCH2COR2; Where R1=(CH2)nCH3 (n=0, 1, 2, 3, 4, 5); R2=(CH2)nCH3 (n=0, 1, 2, 3, 4, 5); and R1=R2 or R1≠R2.

A C5-C12 cyclic ketone optionally substituted with methyl groups and/or optionally unsaturated selected from the group of cyclopentanone, 2-methylcyclopentanone, 3-methylcyclopentanone, cyclohexanone, 2-methylcyclohexanone, 3-methylcyclohexanone, 4-methylcyclohexanone, 3,3,5-trimethylcyclohexanone, 3,5,5-trimethyl-2-cyclohexene-1-one (Isophorone), 2-cyclohexene-1-one, 3-methyl-2-cyclohexene-1-one, 3-methyl-5-heptene-2-one.

According to the invention, there is further provided a mixed metal oxide solution prepared by preparing a metal oxide solution; adding a metal to the solution; and filtering the solution.

According to the invention, there is still further provided a mixed metal oxide solution comprising a soluble mixed metal oxide and a solvent comprising one or more of tetrahydrofuran, dimethylformamide, dimethyl sulphoxide, ethyl acetate, amyl acetate, pyridine, water, acetophenone, isophorone, an alcohol having the general formula:

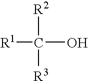

Where R1, R2 and R3 represent one of: R1=R2=R3=H; R1=R2=H; R3=(CH)nCH3 (n=0, 1, 2, 3, 4, 5); R1=H; R2=R3=CH3; R1=H; R2=CH3; R3=CH2CH3; R1=R2=R3=CH3.

An ether having the general formula R1—O—R2; Where R1 and R2 represent one of: R1=R2=CH2CH3; R1=CH3; R2=CH2CH3; R1=R2=(CH2)3CH3; and A ketone having the general formula R1COR2; Where R1=(CH2)nCH3 (n=0, 1, 2, 3, 4, 5); R2=(CH2)nCH3 (n=0, 1, 2, 3, 4, 5); and R1=or R1≠R2.

A diketone having the general formula R1COCH2COR2; Where R1=(CH2)nCH3 (n=0, 1, 2, 3, 4, 5); R2=(CH2)nCH3 (n=0, 1, 2, 3, 4, 5); and R1=R2 or R1≠R2.

A C5-C12 cyclic ketone optionally substituted with methyl groups and/or optionally unsaturated selected from the group of cyclopentanone, 2-methylcyclopentanone, 3-methylcyclopentanone, cyclohexanone, 2-methylcyclohexanone, 3-methylcyclohexanone, 4-methylcyclohexanone, 3,3,5-trimethylcyclohexanone, 3,5,5-trimethyl-2-cyclohexene-1-one (Isophorone), 2-cyclohexene-1-one, 3-methyl-2-cyclohexene-1-one, 3-methyl-5-heptene-2-one.

These soluble metal oxides and mixed metal oxides have excellent long term stability in solution even on exposure to air having important implications for storage. The solutions do not contain any material, which can interfere with the metal oxide during processing.

Solubility

According to the invention, there is still further provided a process for modifying the solubility of a soluble metal oxide comprising; heating the soluble metal oxide to a temperature not greater than 300° C. to provide an insoluble metal oxide; adding an amount of the insoluble metal oxide to an amount of organic acid to provide a metal oxide suspension; heating the metal oxide suspension until the suspension forms a solution; and removing the acid to provide a soluble metal oxide having modified solubility; wherein the insoluble hydrous metal oxide is added to a sufficient amount of organic acid to allow a solution to be formed during heating.

According to the invention, there is further provided a process for modifying the solubility of a soluble metal oxide comprising; adding an amount of soluble metal oxide to an excess amount of organic solvent to form a metal oxide solution; adding acid drop wise to the solution; and removing the organic solvent to provide a soluble metal oxide having modified solubility.

Desirably, the organic acid heretofore referred to may be a C1-C20 aliphatic (cyclic or acyclic) or a C6-C20 aromatic organic acid optionally substituted one or more times with one or more halogen atoms or optionally substituted one or more times with alkoxy groups or optionally substituted one or more times with hydroxyl groups. The organic acid may be one of mono-, di-, or tricarboxylic acids.

The organic acid may be at least one of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acids.

The organic acid may be at least one of acetic, dichloroacetic, trifluoracetic, cyanoacetic, methoxyacetic, propanoic, tartaric, and citric acid.

In one embodiment of the invention, the acid is selected from the group comprising one of orthophosphoric acid, phosphorous acid, hypophosphorous, organophosphonic acids and organophosphinic acids, organoarsonic and organoarsinic acids, and sulphonic acids.

In another embodiment of the invention the acid is replaced with a non-acid selected from the group comprising one of 8-hydroxyquinoline, polyethylene glycol or any non-acid, which is capable of hydrogen bonding.

Preferably the organic solvent is selected from the group comprising of tetrahydrofuran, dimethylformamide, dimethyl sulphoxide, ethyl acetate, amyl acetate, pyridine, water, acetophenone, isophorone, an alcohol having the general formula:

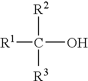

Where R1, R2 and R3 represent one of: R1=R2=R3=H; R1=R2=H; R3=(CH)nCH3 (n=0, 1, 2, 3, 4, 5); R1=H; R2=R3=CH3; R1=H; R2=CH3; R3=CH2CH3; R1=R2=R3=CH3

An ether having the general formula R1-O—R2; Where R1 and R2 represent one of: R1=R2=CH2CH3; R1=CH3; R2=CH2CH3; R1=R2=(CH2)₃CH3; and A ketone having the general formula R1COR2; Where R1=(CH2)nCH3 (n=0, 1, 2, 3, 4, 5); R2=(CH2)nCH3 (n=0, 1, 2, 3, 4, 5); and R1=R2 or R2≠R2.

A diketone having the general formula R1COCH2COR2; Where R1=(CH2)nCH3 (n=0, 1, 2, 3, 4, 5);R2=(CH2)nCH3 (n=0, 1, 2, 3, 4, 5); and R1=or R2 or R1≠R2.

A C5-C12 cyclic ketone optionally substituted with methyl groups and/or optionally unsaturated selected from the group of cyclopentanone, 2-methylcyclopentanone, 3-methylcyclopentanone, cyclohexanone, 2-methylcyclohexanone, 3-methylcyclohexanone, 4-methylcyclohexanone, 3,3,5-trimethylcyclohexanone, 3,5,5-trimethyl-2-cyclohexene-1-one (Isophorone), 2-cyclohexene-1-one, 3-methyl-2-cyclohexene-1-one, 3-methyl-5-heptene-2-one.

Applications

The (mixed) metal oxide solutions may be modified to provide a desired viscosity if necessary to any point up to gel formation. Even in this state total transparency is maintained. Solutions can be highly concentrated or very dilute such that high quality thin and thick oxide films or coatings can be applied to a substrate using spin-coating, aerosol-spray coating, dip-coating, roll-on coating, meniscus coating, bar coating, curtain-flow coating or any other suitable coating technique.

The metal oxides in solution can also be easily applied to fabrics allowing the fabric to act as both a fire retardant and mordant for dyeing applications. Metal oxide solutions and mixed metal oxide solutions also act as precursors for the formation of ceramic colour pigments.

According to the invention, there is provided a metal oxide film or coating formed from the metal oxide solution.

According to the invention there is further provided a mixed metal oxide film or coating formed from the mixed metal oxide solution.

Films or coatings generated in this way possess many desirable characteristics such as scratch resistance, smoothness, elasticity, and porosity. These films or coatings have numerous applications such as forming transparent conducting films or coatings for the electronics industry, forming biocompatible films or coatings having drug retention and release properties, when used as a coating for a pharmaceutical preparation, or when used as in fire retardant composition.

Further applications include use of the films or coatings to reduce the coefficient of friction of moving parts for example engine parts and hip replacements. Moreover, the smoothness of such films/coatings could be exploited in implanted devices or medical devices such as stents (to improve blood flow through the stent), orthopaedic implant for example a prosthesis, or dental implant or spinal implant. The films/coatings could also be applied to monitors for example to reduce glare.

These films/coatings have further applications in the glass industry such as for example as domestic glass coatings to improve impact resistance and plate-glass coatings to improve thermal characteristics.

The metal oxide films/coatings obtained by way of the present invention are suitable for adsorption of biologically active agents (such as drug molecules and vitamins or any molecule that may be desirable to release in a human or animal subject) in medical applications, the adsorption of catalysts for the generation of heterogeneous or homogeneous catalysis systems, adsorption of dyes for coloured coating applications, adsorption of pesticides/insecticides for pest control, and the absorption of fragrances for application in air fresheners. The metal oxide films/coatings may provide for the sustained release of drugs, dyes and fragrances. The coatings may be used to impart a desired refractive index or colour to the substrate.

With regard to the application of these films/coatings in the sustained release of drugs they can also be used for the timed release of drug cocktails by layering and sandwiching of individual drugs. Such technology is of particular importance in the area of stent implantation.

Drugs, dyes, fragrances, pesticides, insecticides and catalysts can be adsorbed onto the surface of the coatings chiefly by two methods: 1). By diffusing into large pores generated in the coatings by annealing at high temperatures. 2). By interaction of the molecule with surface binding groups to form surface coordinated molecules together with hydrogen bonded molecules.

Drugs, dyes, pesticides, insecticides or fragrances suitable for absorption would be those possessing hydroxyl groups, thiol groups, carbonyl groups, amino groups (—NH2), carboxylic acid groups or a combination of these groups.

Additionally prior to formation of the coatings these solutions can be modified for example by attaching surface groups for specific applications. One example of this would be the addition of phosphate groups to improve biocompatibility.

For example the coating can be applied to a substrate comprising at least one of glass, metal such as steel stainless steel or titanium, or plastic composition.

The coating can be applied to a substrate to form an electrically conductive pathway, for example forming part of an electronic device or forming part of an electrochromic device.

Furthermore metal oxide thin films obtained by way of the present invention are suitable for use as spacer layers in Metal Enhanced Fluorophores. Metal Enhanced Fluorescence (MEF) refers to the phenomenon in which enhanced fluorescence of weak fluorophores is observed as a result of their interaction with sub-wavelength metallic structures. Excited fluorophores undergo interactions with metals, creating plasmonic excitations, which in turn radiate into free space and therefore increased fluorescence is detected. The ability to increase the radiative decay rate suggests that any chromophore, even weakly fluorescent species could become brightly fluorescent. A distance of approximately 10 nm between the metallic structure and the fluorophore is however required to prevent quenching of the fluorescence. Because of this a so-called ‘spacer layer’ is needed between the fluorophore and the metallic structure. Metal oxide, particularly Tin(IV) oxide thin films can be used as a spacer layer.

Metal Enhanced Fluorescence (MEF) is very much becoming an important tool in nanobiotechnology. It has a broad variety of applications among which are the detectability of fluorophores and improved DNA detection.

The invention further relates to the use of a soluble metal oxide as a catalyst, the use of a metal oxide solution as a catalyst, the use of a soluble mixed metal oxide as a catalyst, and the use of a mixed metal oxide solution as a catalyst.

The metal oxide solutions also introduce many new possibilities for the development of metal oxide catalysts and immobilised catalysts i.e. catalysts attached to the oxide surface.

The metal oxide in solution has the potential of mimicking or indeed outperforming what are the catalytic activity and roles of organo stannoxanes organotin acetates and other organo metallic base catalysts and thus dispensing with these and what are disadvantages of the use of the latter. In the case of tin oxide, the availability of tin oxide solutions presents unforeseen possibilities for the development of tin oxide based catalysts. These may be of the mixed metal oxide type (e.g. tin/vanadium or tin/copper oxides) or surface bound catalysts, such as chiral oxidation catalysts, which are extremely valuable in the pharmaceutical industry and may be immobilised on the tin oxide surface with relative ease and in high concentration when the oxide is in solution. The metal oxide solutions and mixed metal oxide solutions can act as precursors for the formation of homogenous and heterogenous metal oxide and mixed metal oxide catalysts, with or without other desired groups attached to the surface.

The soluble metal oxides and mixed metal oxides are particularly useful as catalysts due mainly to the manner in which they were prepared. The process of preparing the soluble metal oxides and mixed metal oxides does not result in any undesirable impurities which would prevent their use as catalysts. Additionally as many reactions are carried out in solution, it is advantageous if the catalyst can also be in solution. The metal oxide and mixed metal oxide solutions are suitable for this reason.

According to the invention, there is provided a process for the extraction of tin from a mixed tin, antimony and iron ore comprising: dissolving the ore in a mineral acid to form a mineral acid solution comprising aqueous tin, antimony and iron species; increasing the pH of the solution to form hydrous tin, antimony and iron oxides within the solution and to precipitate hydrous tin, antimony and iron oxides from solution; adding an excess amount of organic acid to the hydrous oxides to form an organic acid suspension; heating the suspension; filtering the suspension; and removing the organic acid to provide a soluble tin oxide with iron residue.

Preferably, the process further comprises: dissolving the soluble tin oxide with iron residue in an organic solvent to provide a solution; maintaining the soluble tin oxide in solution for at least 24 hours; filtering the solution to remove the iron residue; and removing the organic solvent to provide a soluble tin oxide.

Further preferably the coating will have a roughness factor (Ra) for example of less than or equal to about 0.6 nm, desirably less than or equal to about 0.5 nm, or suitably less than or equal to about 0.45 nm.

A coating with a Young's modulus of, for example, less than or equal to 66 Gpa, or desirably with a Young's modulus less than 63 Gpa.

A coating wherein delamination of the coating from a substrate on which it is coated occurs for example at a load of greater than about 4.0 mN, or desirably at a load of greater than about 6.0 mN.

### DETAILED DESCRIPTION OF THE INVENTION

The invention will be more clearly understood from the following description of some embodiments thereof given by way of example only and with reference to the accompanying drawings wherein:

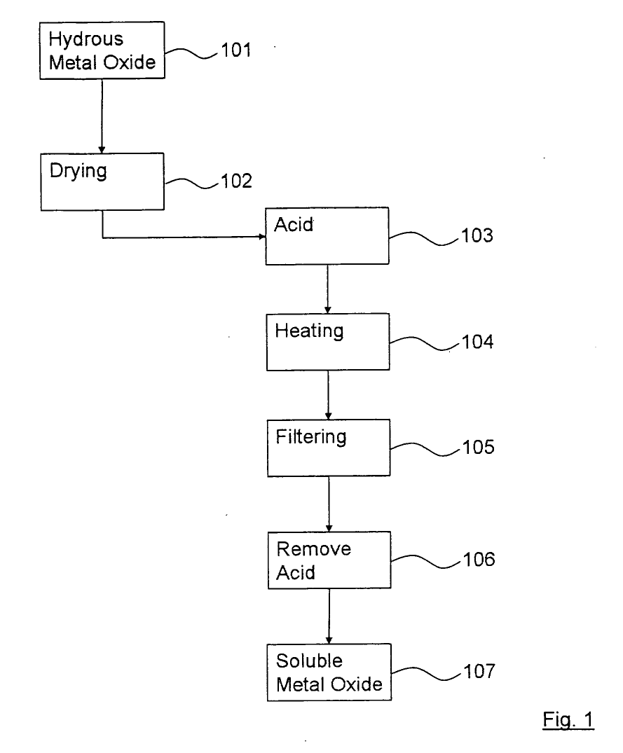

FIG. 1 is a process outline for the preparation of a soluble metal oxide.

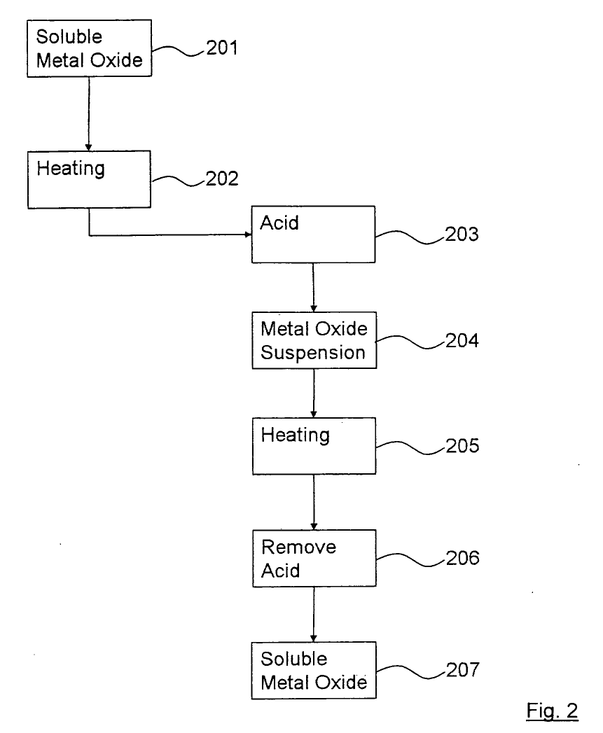

FIG. 2 is a process outline for the modification of the solubility of a soluble metal oxide.

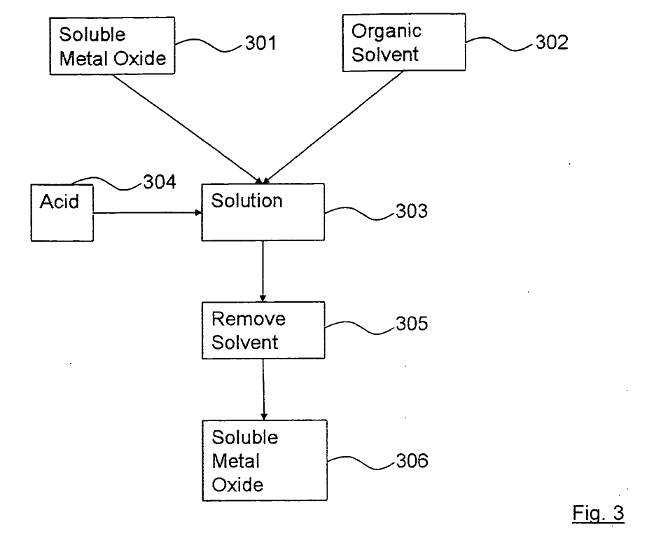

FIG. 3 is an alternative process outline for the modification to the solubility of a soluble metal oxide.

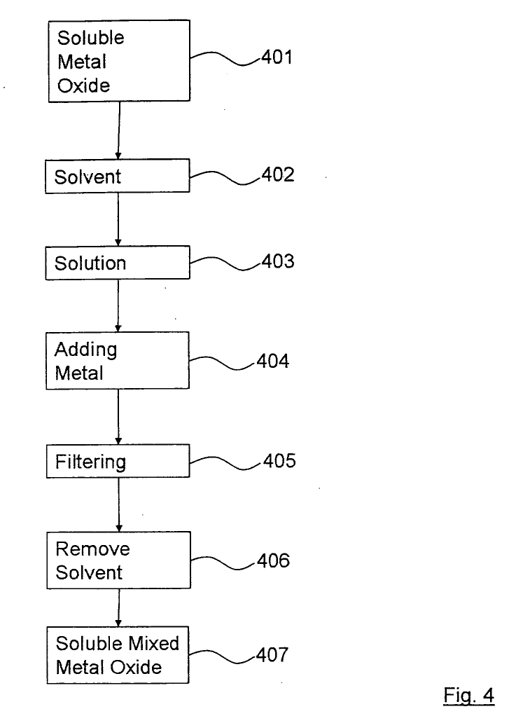

FIG. 4 is a process outline for the preparation of a soluble mixed metal oxide.

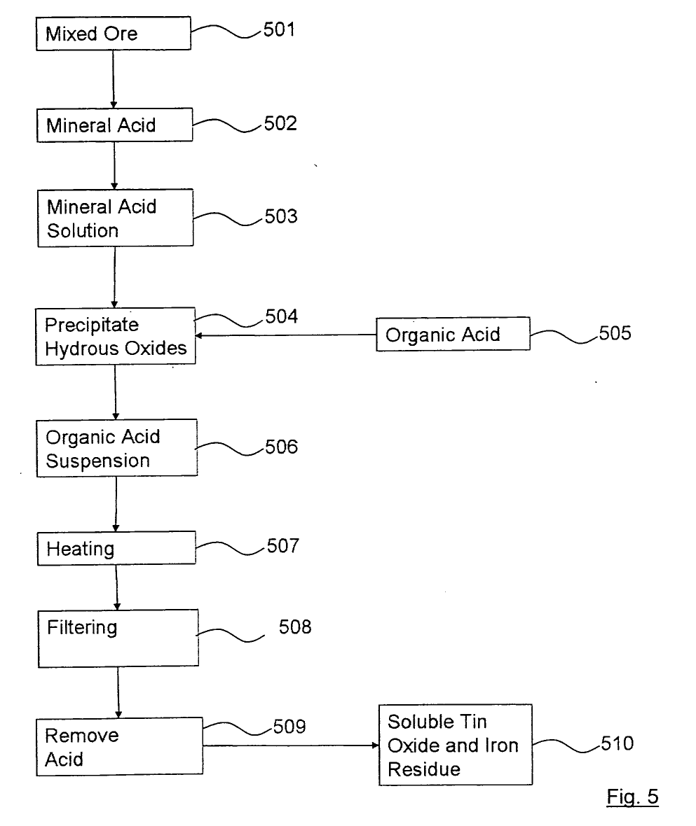

FIG. 5 is a process outline for the extraction of tin from a mixed tin, antimony and iron ore.

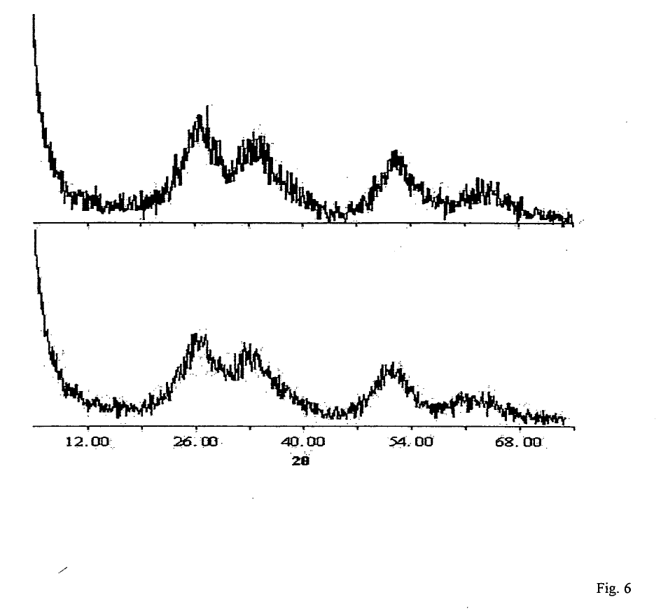

FIG. 6 illustrates powder diffraction patterns of hydrous insoluble tin oxide (lower) and soluble tin oxide (upper).

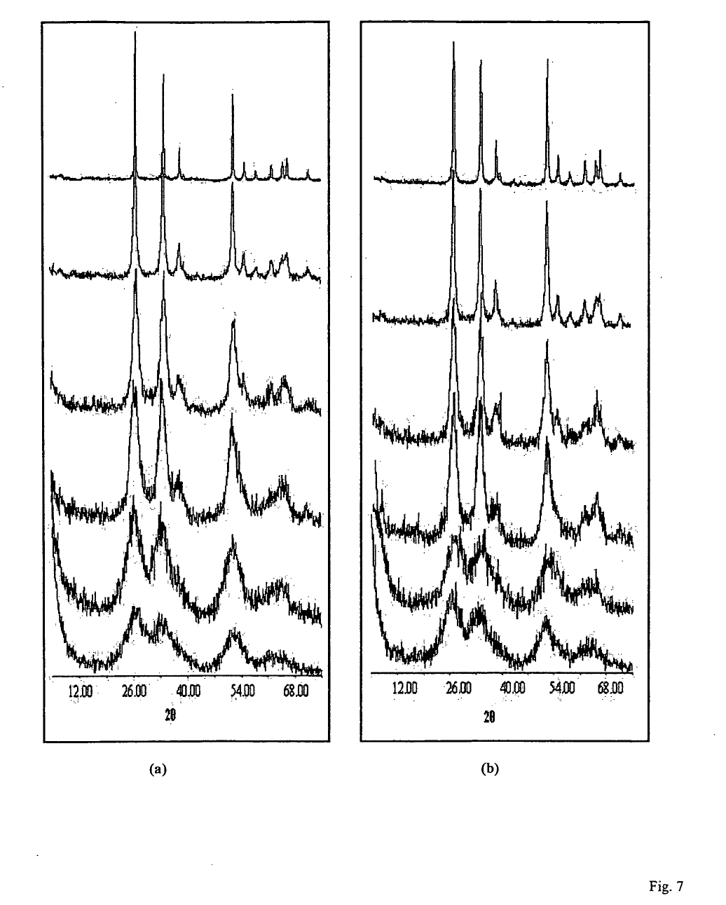

FIG. 7 illustrates powder diffraction patterns of hydrous insoluble tin oxide (a) and soluble tin oxide (b) at temperatures of 200° C., 400° C., 600° C., 800° C. and 900° C. (Temperatures increase from bottom to top.)

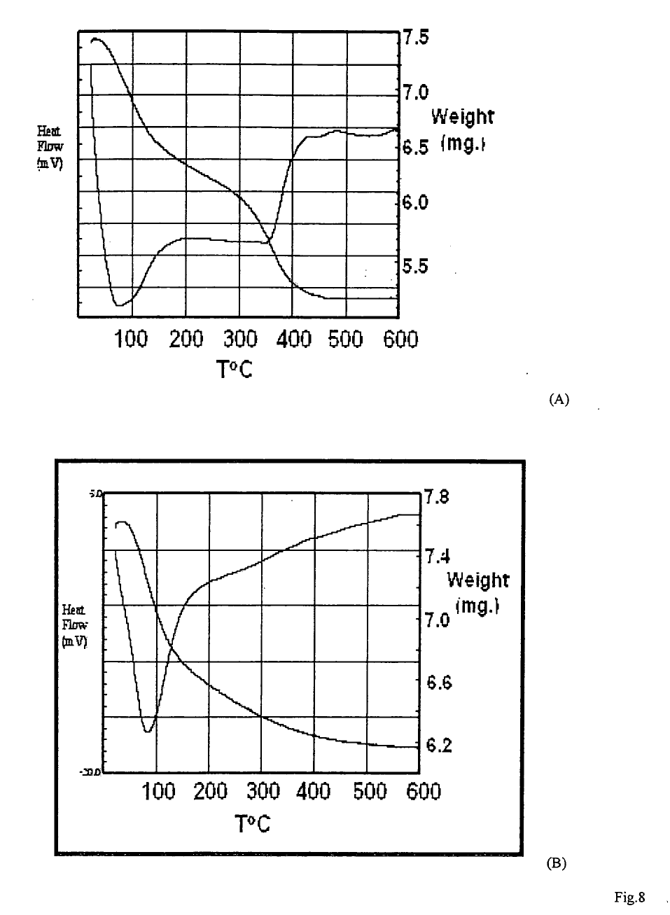

FIG. 8 illustrates thermograms of hydrous insoluble tin oxide (b) and soluble tin oxide (a).

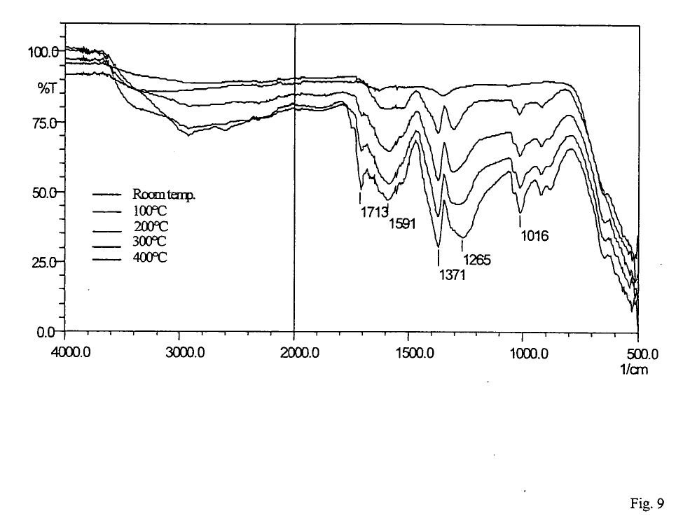

FIG. 9 illustrates the room temperature infrared spectra of soluble tin oxide that were previously heat treated at the temperatures indicated.

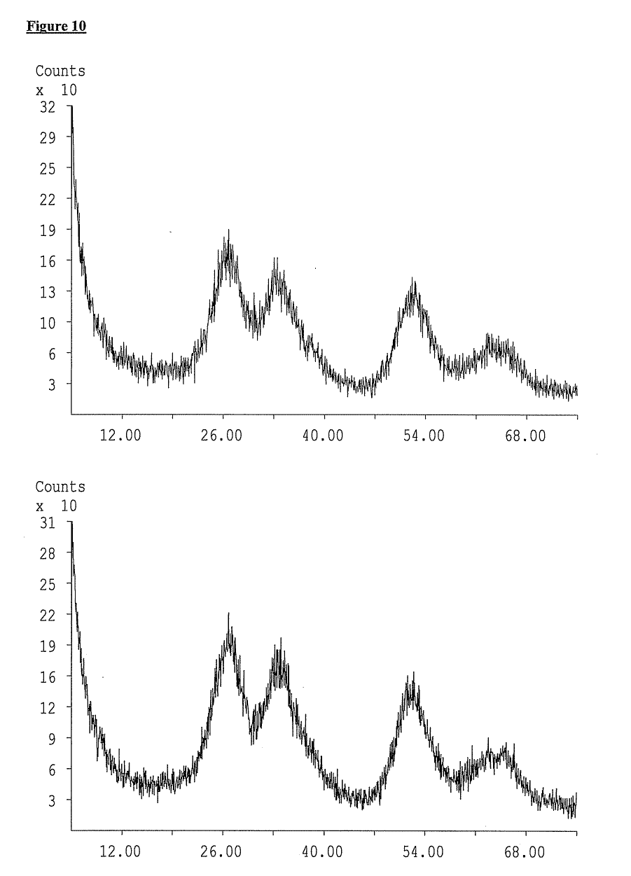

FIG. 10 X-Ray Diffraction patterns of soluble tin oxide obtained by the preparation procedure using methoxyacetic acid showing diffraction patterns for both the non-ether washed (top) and ether washed (bottom) soluble tin oxides.

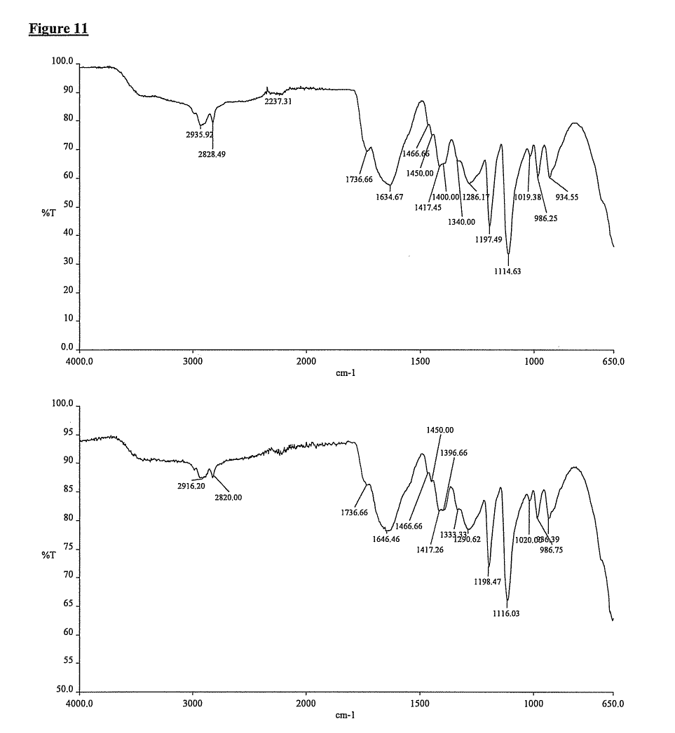

FIG. 11 Infrared spectra of non-ether washed (top) and ether washed (bottom) samples of soluble tin oxide prepared using methoxyacetic acid.

FIG. 12 Infrared spectrum of soluble tin oxide prepared using cyanoacetic acid.

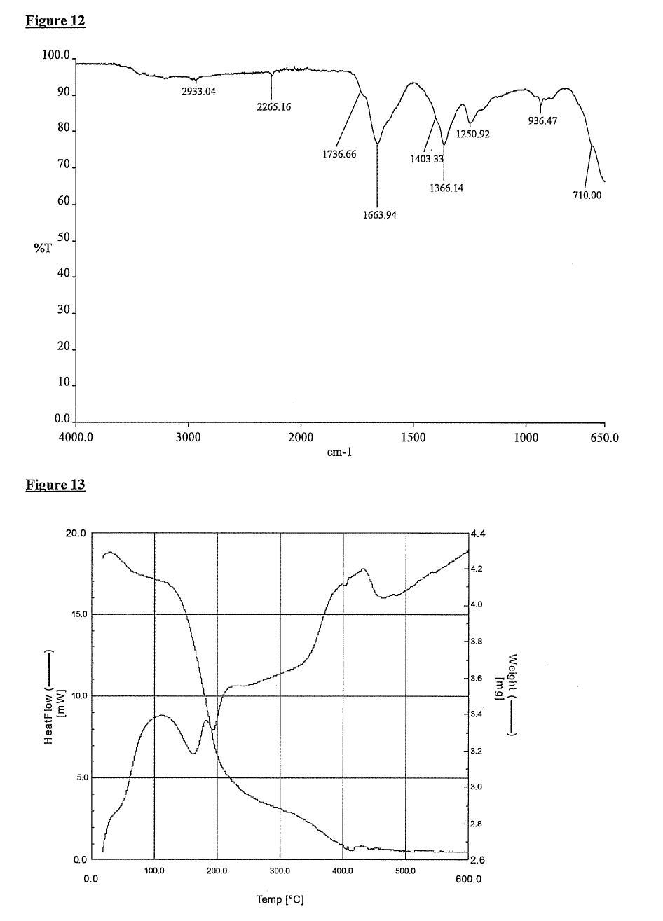

FIG. 13 TGA/DSC traces for tin oxide prepared using cyanoacetic acid.

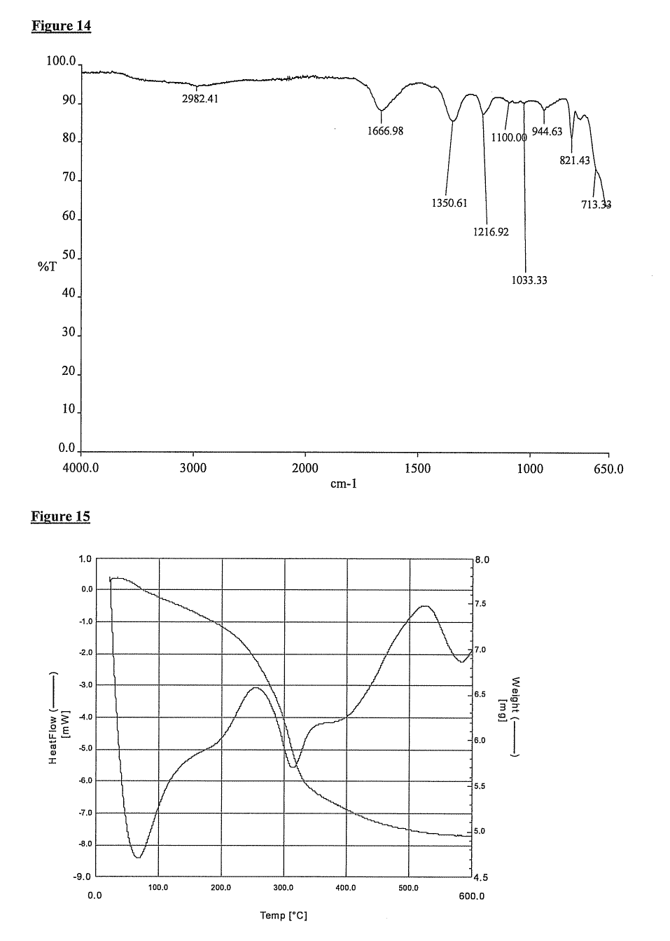

FIG. 14 Infrared Spectrum of Soluble Tin Oxide prepared using Dichloroacetic Acid.

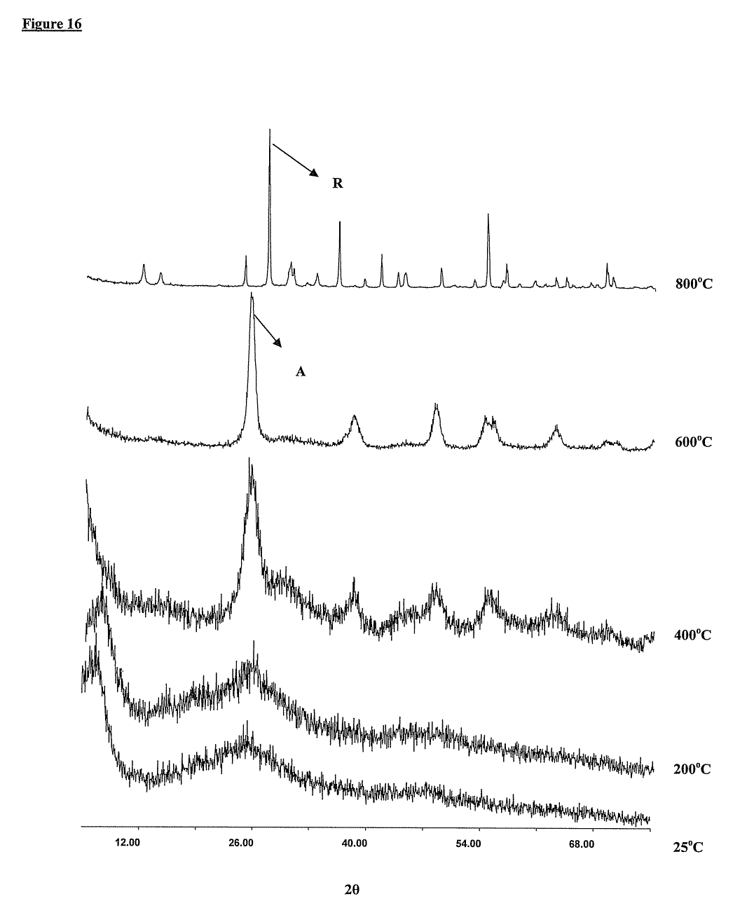

FIG. 15 TGA/DSC Traces for Soluble Tin Oxide prepared using Dichloroacetic Acid.

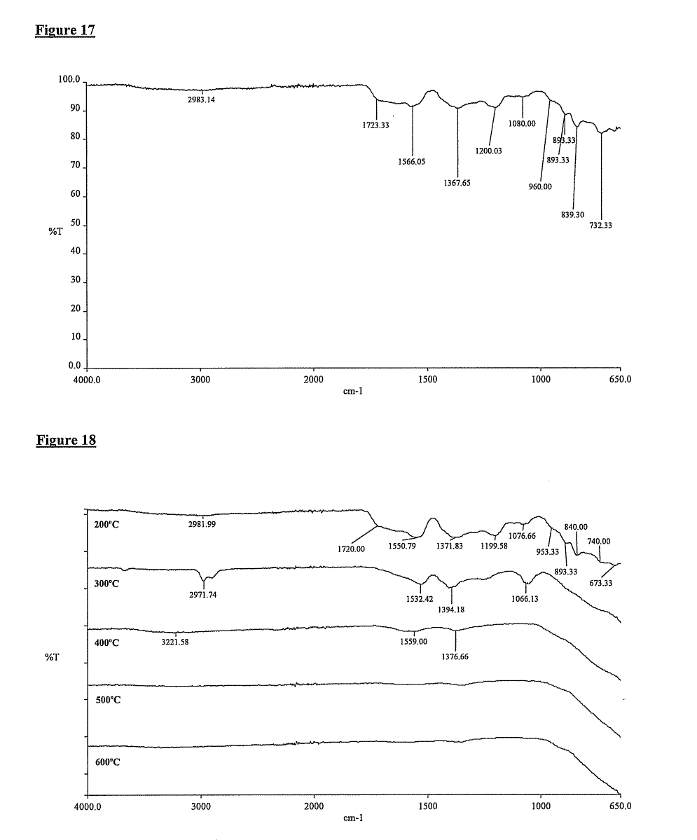

FIG. 16 X-ray powder diffraction patterns of titanium(IV) oxide/citrate heat treated for two hours at the various temperatures indicated (A=Anatase and R=Rutile).

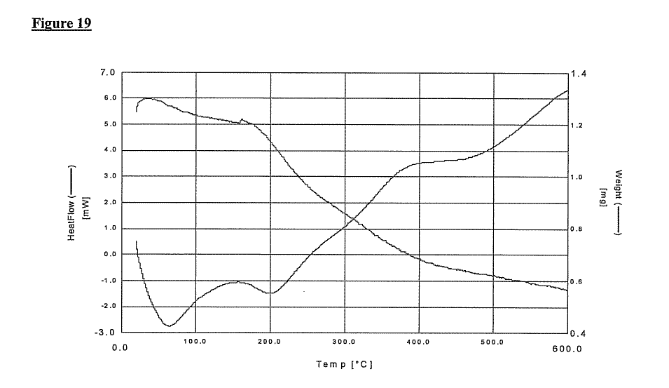

FIG. 17 Typical infrared spectrum of titanium(IV) oxide/citrate.

FIG. 18 Infrared spectra of titanium(IV) oxide/citrate heat treated for two hours at the various temperatures indicated.

FIG. 19 Typical thermogram of titanium(IV) oxide/citrate.

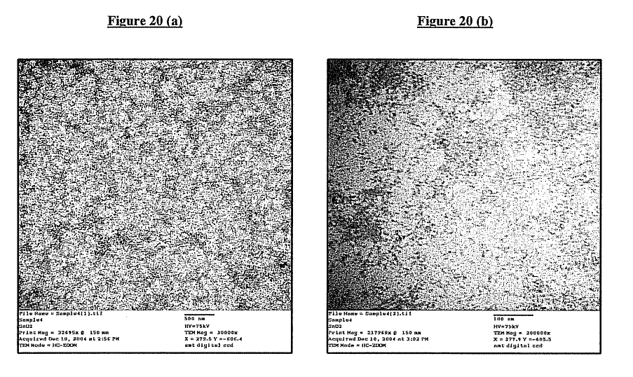

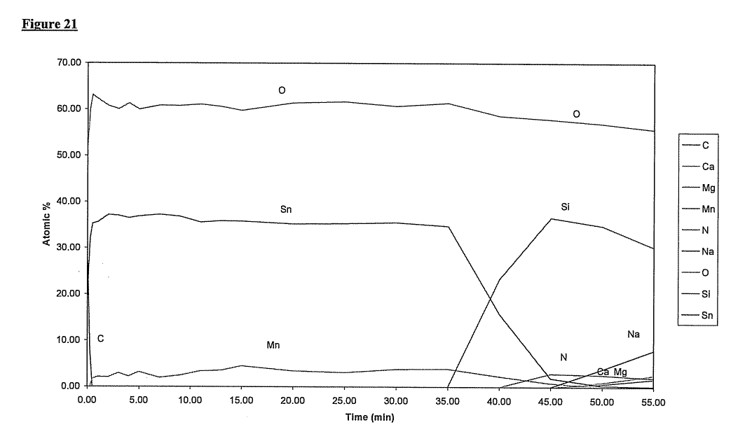

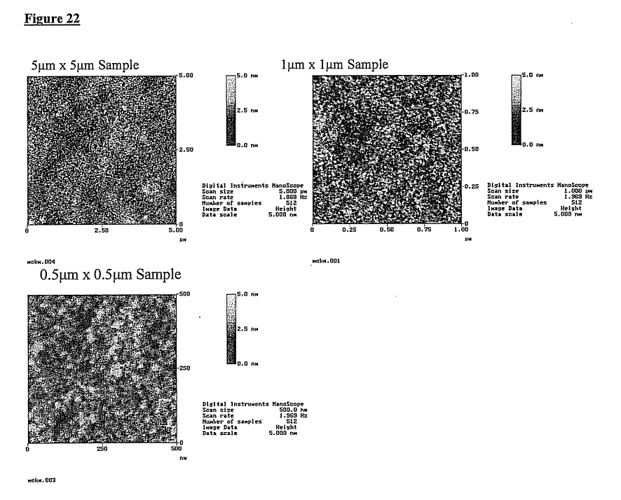

FIG. 20 (a) and FIG. 10 (b) relate to TEM (Transmission Electron Microscopy) images of SnO2 nanoparticles magnified (a) 30 k times and (b) 200 k times.

FIG. 21 relates to graph of the XPS (X-ray Photoelectron Spectroscopy) depth profiling analysis of a coating of Tin(IV) oxide doped with manganese on silica coated glass.

FIG. 22 shows Atomic Force Spectroscopy images of SnO2 coatings obtained from dip coating a glass sample with soluble tin(IV) oxide acetate.

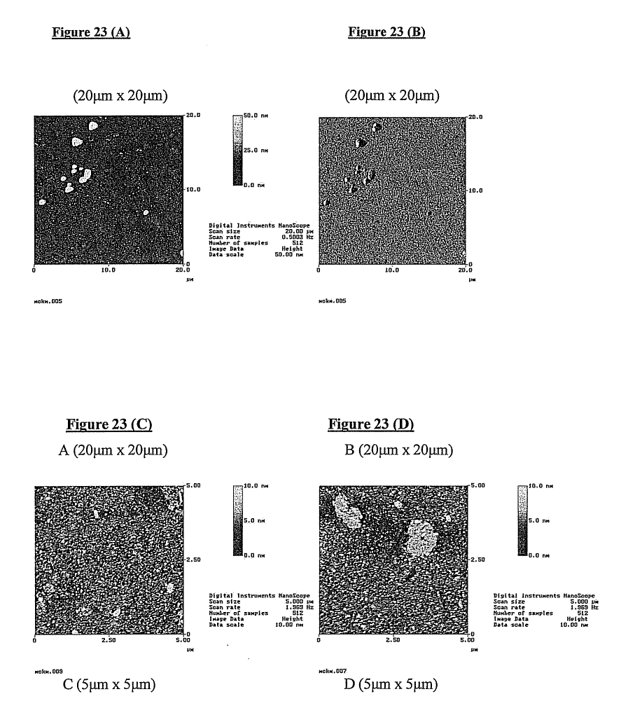

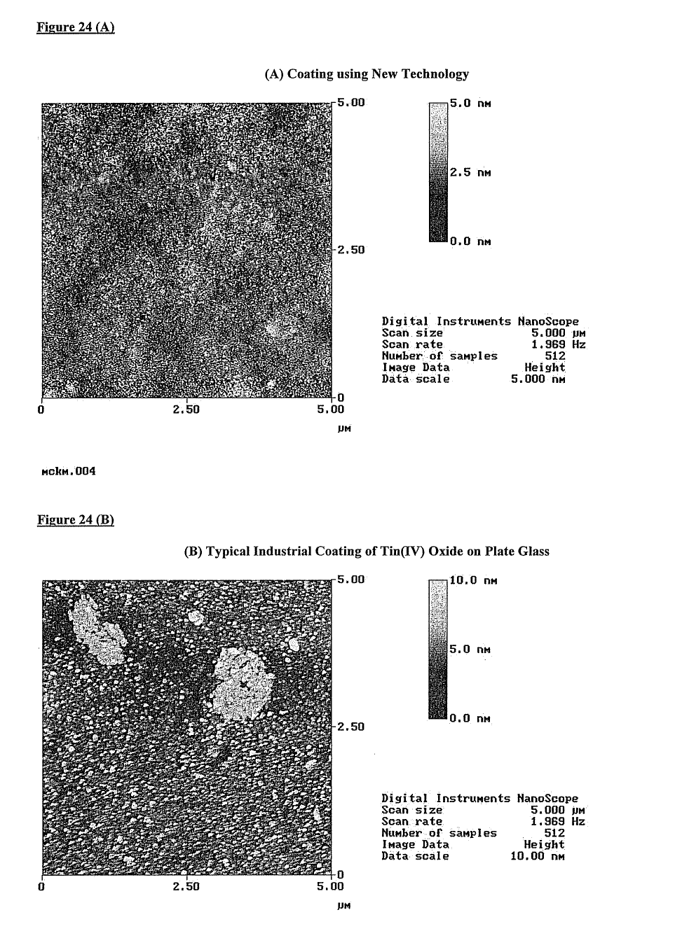

FIG. 23 (A), FIG. 13 (B), FIG. 13 (C) and FIG. 13 (D) relate to Atomic Force Spectroscopy images of SnO2 coatings obtained for typical Tin(IV) oxide coatings on plate glass.

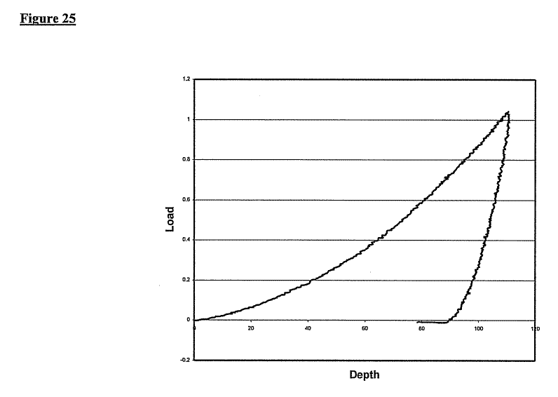

FIG. 24 (A) and FIG. 14 (B) display a direct comparison of the surface smoothness of Tin(IV) oxide coatings obtained from the present invention and a typical industrial Tin(IV) oxide coating. FIG. 14 (A) displays a coating formed from the present invention on plate glass and FIG. 14 (B) shows a typical industrial coating of Tin(IV) Oxide on plate Glass.

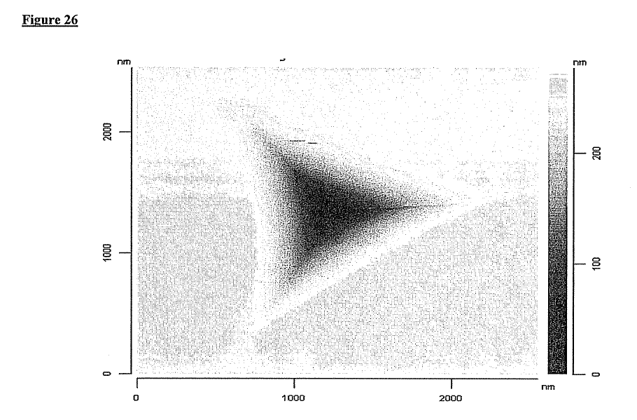

FIG. 25 shows a Load/Displacement curve for nanoindentation of 440 nm tin oxide film on silicon substrate, where the max load is 1 mN and the approach speed is 2000 nm/min.

FIG. 26 shows a high magnification image of the indent created in a typical Tin(IV) oxide coating.

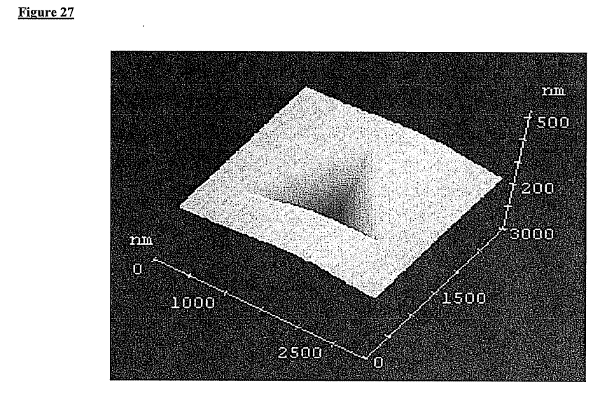

FIG. 27 shows a 3D Image of a nano indent on Tin(IV) oxide coating on a silicon substrate.

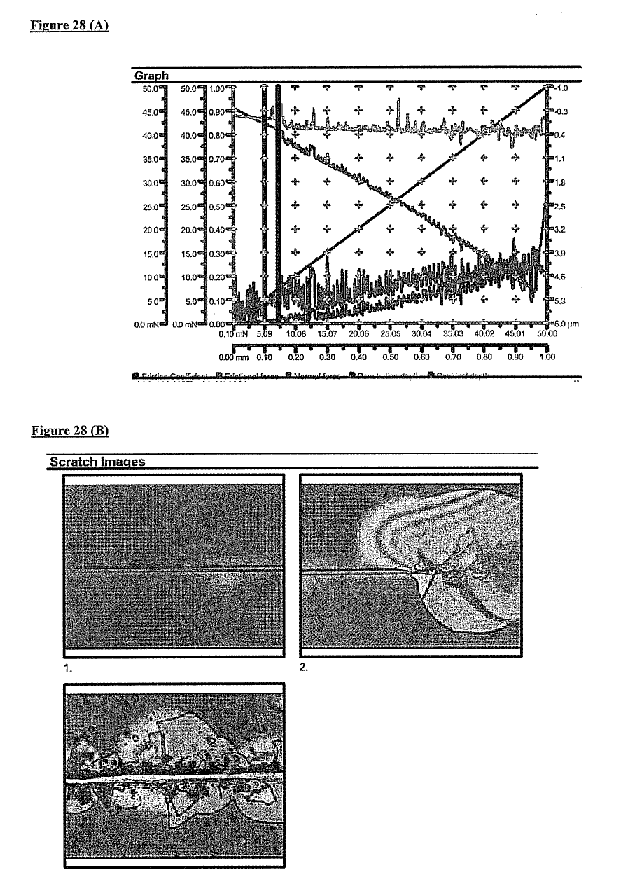

FIG. 28 (A) relate to Nano Scratch Tests on a typical Tin(IV) oxide coating on Silica and FIG. 28 (B) displays scratch images for nano scratch tests on typical Tin(IV) oxide coating on Silica.

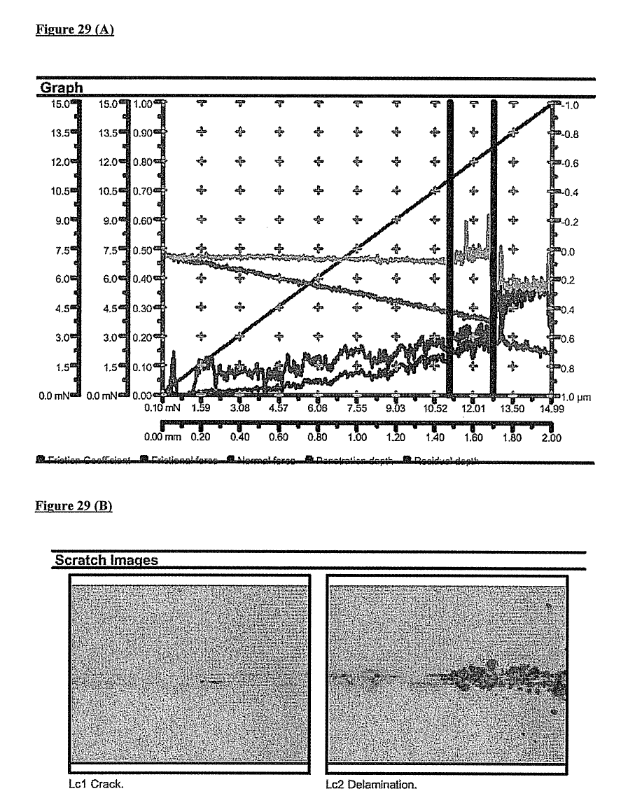

FIG. 29 (A) relates to (A) Nano Scratch Tests on a DLC coating on Silica and FIG. 29 (B) displays scratch images for nano scratch tests on a DLC coating on Silica.

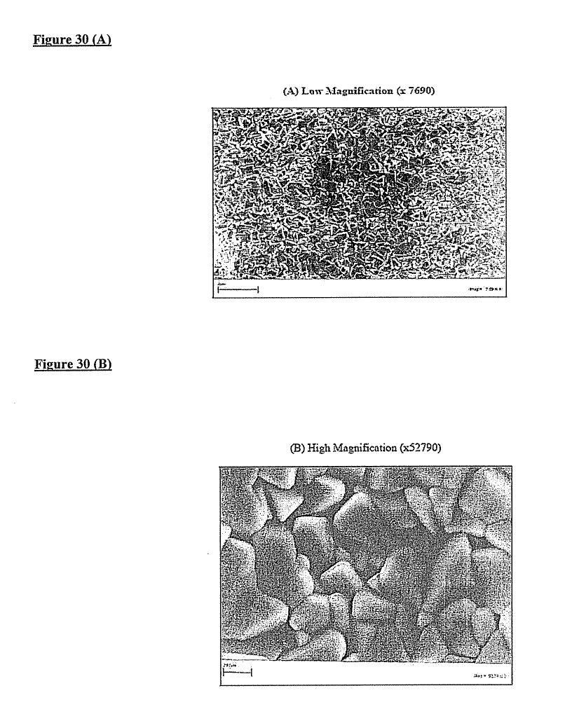

FIG. 30 (A) shows the porosity of Titanium(IV) Oxide coatings, at low magnification, deposited on stainless steel and annealed at 800° C. and FIG. 30 (B) shows the porosity of Titanium(IV) Oxide Coatings deposited on stainless steel at high magnification and annealed at 800° C.

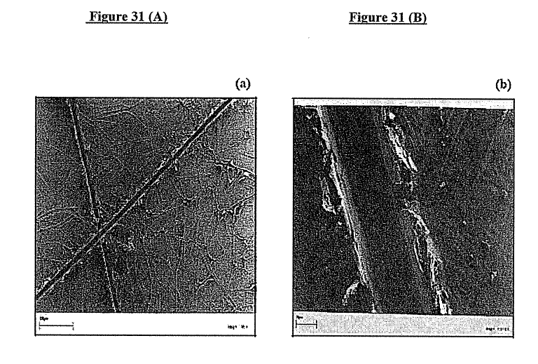

FIG. 31 (A) shows a plan view SEM micrographs at low magnification of the scratch onto one coating of titanium (IV) oxide on a steel substrate that was annealed at 400° C. for 3 hrs and FIG. 31 (B) shows a plan view SEM micrographs at high magnification of the scratch onto one coating of titanium(IV) oxide on a steel substrate that was annealed at 400° C. for 3 hrs.

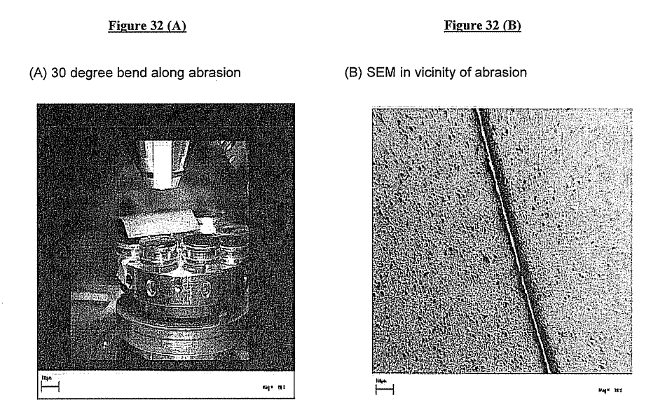

FIG. 32 (A) and FIG. 32 (B) relate to Surface Integrity Challenge of Titanium (IV) oxide coating on stainless steel. FIG. 32(a) shows a perspective view of a 30 degree bend along an abrasion of the material and FIG. 32 (B) gives a plan view of an SEM image in vicinity of abrasion.

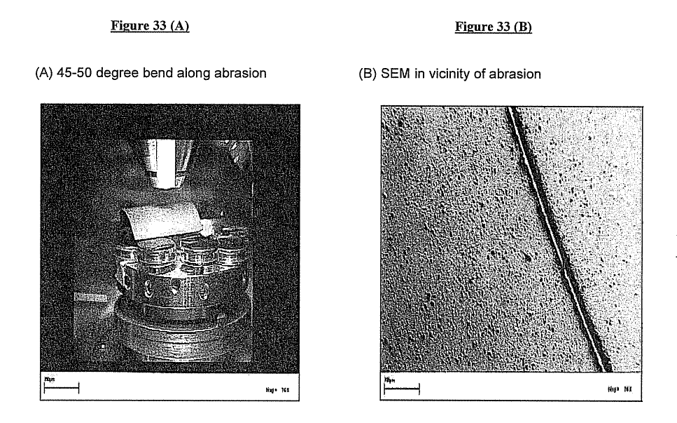

FIG. 33 (A) and FIG. 33 (B) relate to Surface Integrity Challenge of Titanium (IV) oxide coating on stainless steel. FIG. 33(a) shows a perspective view of a 45-50 degree bend along an abrasion of the material and FIG. 33 (B) gives a plan view of an SEM image in vicinity of abrasion.

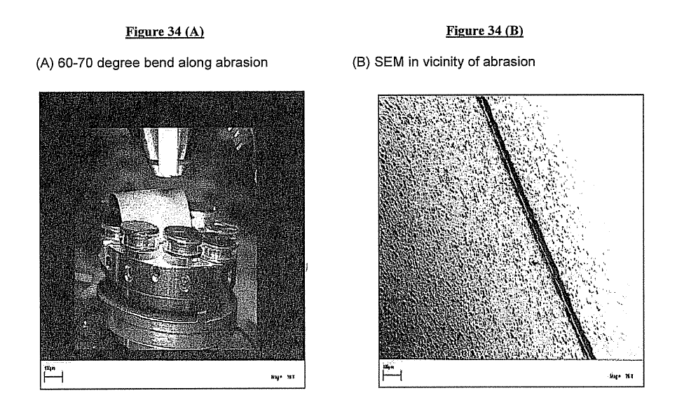

FIG. 34 (A) and FIG. 34 (B) relate to Surface Integrity Challenge of Titanium (IV) oxide coating on stainless steel. FIG. 34(a) shows a perspective view of a 60-70 degree bend along an abrasion of the material and FIG. 34 (B) gives a plan view of an SEM image in vicinity of abrasion.

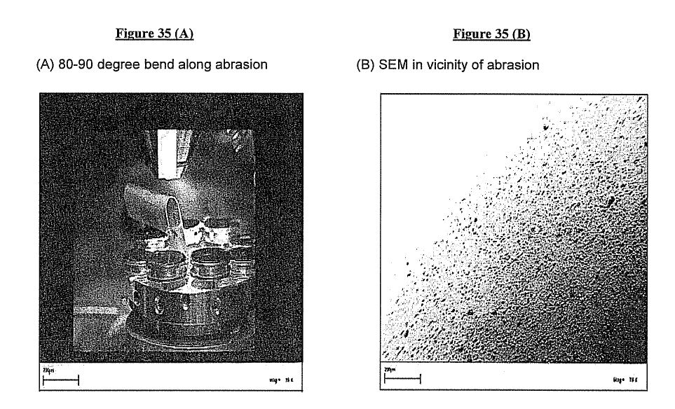

FIG. 35 (A) and FIG. 35 (B) relate to Surface Integrity Challenge of Titanium (IV) oxide coating on stainless steel. FIG. 35(a) shows a perspective view of a 80-90 degree bend along an abrasion of the material and FIG. 35 (B) gives a plan view of an SEM image in vicinity of abrasion.

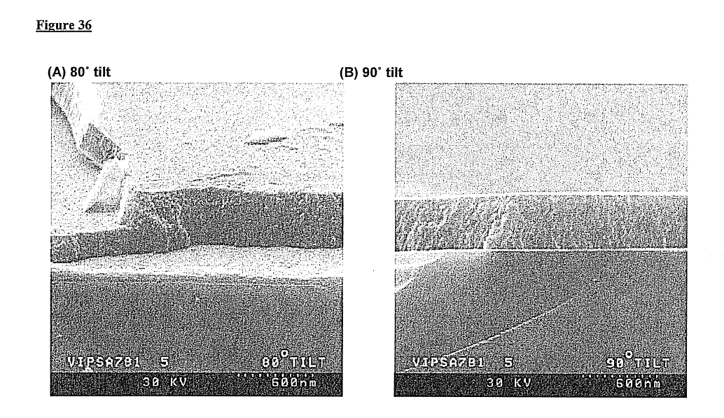

FIG. 36 shows High magnification cross sectional SEM images of three coatings of tin(IV) oxide on SiO₂ coated glass annealed at 500° C. FIG. 36(a) shows an image at 80° tilt and FIG. 36 (b) shows an image at 90° tilt.

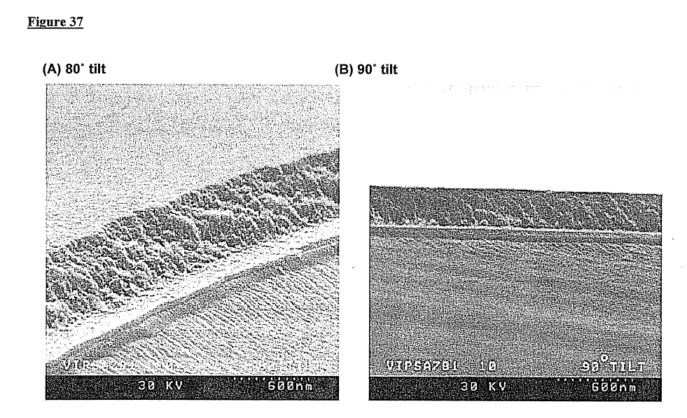

FIG. 37 shows perspective SEM images of the cross sectional microstructures of one coating of titanium(IV) oxide on SiO₂ coated glass annealed at 500° C. FIG. 27(a) shows an image at 80° tilt while FIG. 37(b) shows an image at 90° tilt

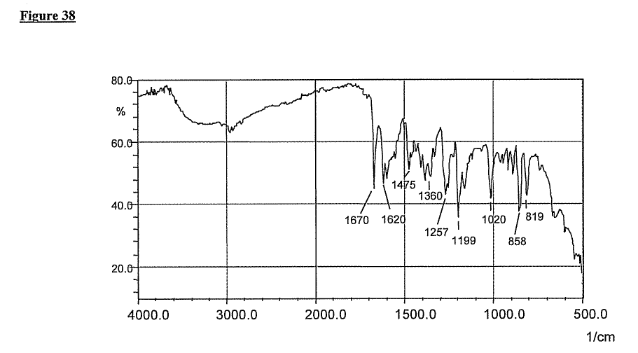

FIG. 38 shows a graph of the infrared spectrum of the tin(IV) oxide acetate/naproxen derivative.

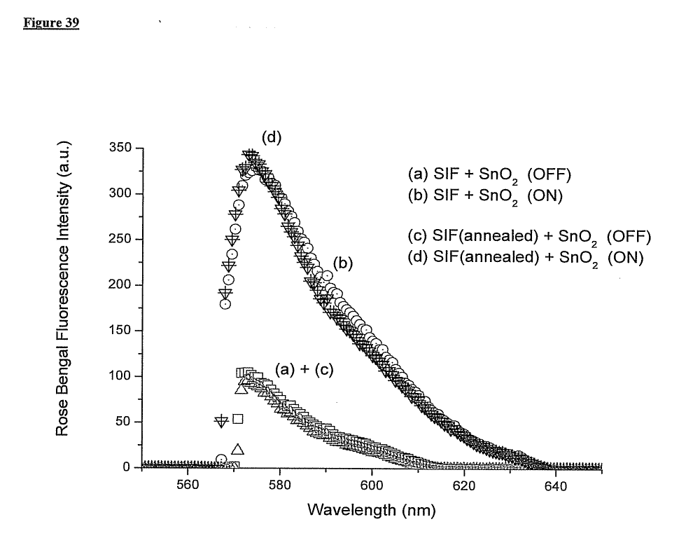

FIG. 39 shows a graph of Rose Bengal OFF and ON SIF (Silver Island Film) fluorescence intensity. Where Rose Bengal is a standard or model fluorophore.

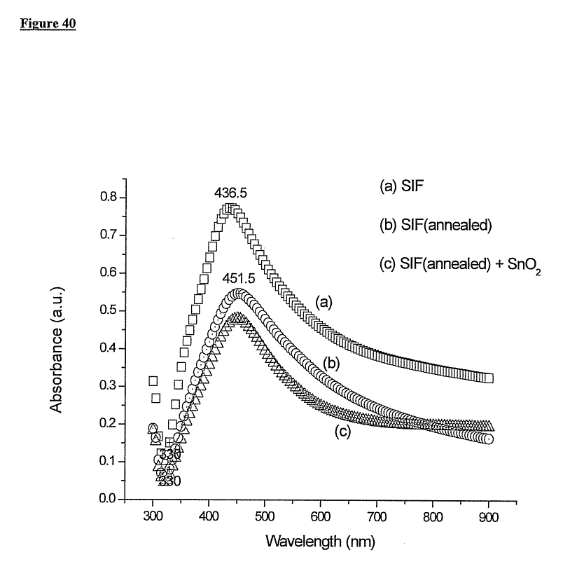

FIG. 40 shows a graph of the UV-VIS absorption spectra of (a) Silver Island Film (SIF), (b) SIF(annealed), (c) SIF(annealed) and SnO2 coated substrates.

### EXPERIMENTAL

According to FIG. 1 there is provided a process outline for the production of a soluble metal oxide.

In step 101 hydrous insoluble metal oxide is obtained and is dried at room temperature until it crumbles into a powder in step 102. In step 103, an amount of the dried hydrous metal oxide is added to an amount of organic acid to form a metal oxide suspension. In step 104 the metal oxide suspension is heated until the suspension forms a solution. The solution is filtered to remove any undissolved material in step 105. In step 106, the organic acid is removed to provide the soluble metal oxide in step 107.

Any amount of the hydrous insoluble metal oxide can be added to the organic acid as long as there is sufficient acid present for a solution to form during heating. Obviously filtering is an optional step which is only carried out if necessary. It will be appreciated that the acid removal step can be omitted and the resultant solution can be used in this form.

The hydrous metal oxide may be obtained commercially and can also be prepared by hydrolysis of a metal tetrachloride or metal alkoxide or by any other preparative method. A typical process for the preparation of hydrous Tin(IV) oxide by hydrolysis of Tin(IV) tetrachloride is as follows. 20 cm3 of tin tetrachloride was added to 200 cm3 of water to give a highly acidic solution. The pH of this solution was slowly raised to 6 after which the hydrous tin oxide was removed by centrifuging the solution. The very fine white solid was washed 8 times with distilled water to effect the total removal of chloride. Following a final washing with acetone, to speed the drying process, the solid was left to dry in the open atmosphere at room temperature. Approximately 10.5 g. of dry hydrous tin oxide was obtained by this process. This hydrous oxide is insoluble in all organic solvents and in water.

According to FIG. 2 there is provided a process outline for the modification of the solubility of a soluble metal oxide.

In step 201 the soluble metal oxide is heated to a temperature not greater than 300° C. until it becomes insoluble in step 202. In step 203 an amount of the insoluble metal oxide is added to an amount of organic acid to form a metal oxide suspension in step 204. The metal oxide suspension is heated until the suspension forms a solution in step 205. In step 206 the acid is removed to provide a soluble metal oxide of modified solubility in step 207. The amounts of insoluble metal oxide and acid required are determined as above.

According to FIG. 3 there is provided an alternative process outline for the modification of the solubility of a soluble metal oxide.

In step 301 an amount of soluble metal oxide is added to an amount of organic solvent in step 302 to form a solution in step 303. In step 304 acid is added dropwise to the solution and the solvent is removed from the solution in step 305 to provide a soluble metal oxide in step 306.

It should be noted that instead of adding acid to the metal oxide suspension that alternatively a non-acid which is capable of hydrogen bonding could be added. For example, the acid could be substituted for 8-hydroxyquinoline and in this case the resultant soluble metal oxide would be soluble in methanol.

According to FIG. 4 there is provided a process outline for the preparation of a soluble mixed metal oxide.

In step 401 a soluble metal oxide is obtained by the process as outlined in FIG. 1. In step 402 the metal oxide is dissolved in a solvent to provide a solution in step 403. In step 404 an additional metal is added to the solution. The solution is filtered in step 405. The solvent is removed from the solution in step 406 to provide a soluble mixed metal oxide in step 407.

It will be appreciated that instead of dissolving the metal oxide in a solvent to provide a solution it is further possible to use the solution obtained in FIG. 1. Optionally the solution can be heated before it is filtered.

According to FIG. 5 there is provided a process outline for the extraction of tin from a mixed tin, antimony and iron ore.

In step 501 a mixed ore is obtained and is dissolved in a mineral acid in step 502 to provide a mineral acid solution in step 503. In step 504 the pH of the solution is increased to precipitate hydrous tin, antimony and iron oxides from the solution. In step 505 an amount of organic acid is added to the hydrous oxides to form an organic acid suspension in step 506. The suspension is heated in step 507. In step 508 the suspension is filtered. In step 509 the organic acid is removed to provide a soluble tin oxide with iron residue in step 510. The iron residue can be removed downstream by dissolving the soluble tin oxide and iron residue in an organic solvent to provide a solution, maintaining in solution for at least a day, filtering the solution to remove the iron residue and removing a soluble tin oxide.

The amount of organic acid added should be sufficient to allow a solution to form during heating.

In the following examples, it will be understood that the tin oxide is tetravalent tin oxide or tin (iv) oxide having regard to the preparation route as described above.

### Example 1

### Preparation of a Soluble Tin Oxide Using Acetic Acid

Preparation

Insoluble hydrous tin oxide was obtained and dried at room temperature until the tin oxide crumbled into a powder. 10.5 g of the dried insoluble hydrous tin oxide was added to 100 cm3 of glacial acetic acid to provide a tin oxide suspension. The suspension was stirred for one hour at room temperature. No apparent dissolution of the insoluble tin oxide was noted. The tin oxide suspension was heated to a temperature of approximately 85° C. and at this temperature the oxide was slowly consumed into the solution. When the temperature approached 100° C. the solids had completely disappeared giving a clear solution. Heating was discontinued and the solution was filtered. The acetic acid was removed using a suitable evaporating apparatus such as a Rotavap™ at a pressure of 17 mm.Hg provided by a water pump. The remaining white solid was the soluble tin oxide.

Analysis

Analysis of the soluble tin oxide showed that it had a carbon content of approximately 9% to 10% and an acetate content in the region of between 22% and 24%. The carbon content was measured using a carbon, nitrogen, hydrogen analyser and the amount of carbon correlates to the amount of acetate present.

The soluble tin oxide was found to be soluble in cold glacial acetic acid and cold methanol. It was found that approximately 1000 g of soluble tin oxide could be dissolved in 1 litre of methanol at room temperature to give a clear transparent solution. The soluble tin oxide was also found to have some solubility in ethanol and water.

X-ray Powder Diffractometry Studies

Powder diffraction patterns of hydrous insoluble tin oxide and soluble tin oxide are shown in FIG. 6. The patterns are essentially identical. The average particle size of the insoluble tin oxide and soluble tin oxide was calculated to be 19 Å.

Samples of both insoluble tin oxide and soluble tin oxide were heated to temperatures of 200° C., 400° C., 600° C., 800° C. and 900° C. At each of these temperatures powder diffraction patterns and infrared spectra were recorded. The diffraction patterns are indicated in FIG. 7. As the temperature was raised sintering occurred (i.e. an increase in particle size with increasing temperature) to give large crystallites, this is indicated by a narrowing of the diffraction lines. Sintering also results in the loss of water molecules and is due to the reaction denoted by the following formula: 2(—Sn—OH)→—Sn—O—Sn—+H2O.

The response of the oxides to heating was found to be essentially identical except at 400° C. where the diffraction lines of soluble tin oxide were found to be broader than those of insoluble tin oxide, thus indicating that at this temperature a slight retardation of the sintering process occurs as a result of the presence of the acetate groups.

Thermogravimetric Analysis

A number of soluble tin oxide samples were prepared as above and thermograms for each of the samples were recorded. These thermograms showed consistency both in terms of thermogram form and in terms of quantitative weight losses over the temperature range studied (room temperature to 600° C.). Typical thermograms of both insoluble tin oxide and soluble tin oxide are shown in FIG. 8. The thermogram for insoluble tin oxide is typical to that recorded by many authors and shows the greatest weight loss occurring up to a temperature of approximately 120° C. and tailing off with increasing temperature beyond this point. In contrast, the thermogram for the soluble tin oxide shows three well defined areas of weight loss in each of which there is a linear relationship between the weight loss and temperature. There was found to be a steep weight loss with increasing temperature in the range 25-120° C. and this was followed by a tailing off into a second region extending to approximately 300° C. The slope of the line in this region is very much less than that in the lower temperature region. Finally, a further marked increase in weight loss with increasing temperature occurred in the approximate region 300-450° C. No further significant weight loss beyond this point was recorded.

Weight loss up to 300° C. is largely associated with loss of hydrogen bound acetic acid while weight loss in the region of 300 to 400° C. is associated with loss of acetate bound to tin atoms on the surface of the crystallites together with decomposition of surface bound acetates. Tin acetates, in which acetate is coordinated to tin, show acetate weight loss in this area and thus it can be assumed that for soluble tin oxide this is also weight loss due to acetate bonded to tin, an assumption which is supported by infrared data.

Infrared Spectra

The room temperature infrared spectra of samples of soluble tin oxide that were previously heat treated at the temperatures indicated are shown in FIG. 9. The infrared spectra of soluble tin oxide at room temperature show a very broad absorption in the region 1450-1650 cm−1: This is a general region where the acetate υ(C—O)asym. is observed. A broad intense absorption occurs at approximately 1265 cm−1 and a much sharper absorption at 1371 cm−1, both of which are attributable to the acetate υ(C—O)sym related vibrations. A sharp band is observed at 1713 cm−1. It has been found that this band results from acetic acid forming a hydrogen bond to acetate bonded to tin. Significantly, the band diminishes with increasing temperature and samples heated to 300° C. no longer display this band. This is consistent with the thermogravimetric studies, which indicate that the loss of weight up to 300° C. is associated with acetate not bound directly to tin. The absorption in the region 1450-1650 cm−1 of the spectrum of the sample heated to 300° C. is attributable to acetate bonded to tin. The broadness of the absorption is indicative of the presence of more than one type of tin bound acetate and this is further supported by the presence of bands at approximately 1265 and 1371 cm−1.

When acetate is bonded to tin through one of its oxygen atoms (i.e. unidentate acetate) as, for example, in K2[Sn(acetate)6] υ(C—O)asym is observed in the approximate region 1630-1675 cm.−1 region while υ(C—O)sym is observed above 1300-1340 cm.−1 region. On the other hand, when acetate is bonded through both its oxygen atoms (i.e. bidentate acetate), υ(C—O) asym is observed close to 1560 cm−1, while υ(C—O) sym is observed at a frequency close to 1400 cm.−1. Thus, the spectrum of soluble tin oxide that has been heated to 300° C. shows the presence of both unidentate and bidentate acetates bonded to tin. The room temperature infrared spectrum of the sample that was heat treated at 400° C. does not exhibit any of the absorption bands characteristic of acetate, thus indicating the complete removal of bound acetate on such heat treatment.

The reaction of the components in the above process can be further illustrated by the following reaction scheme:

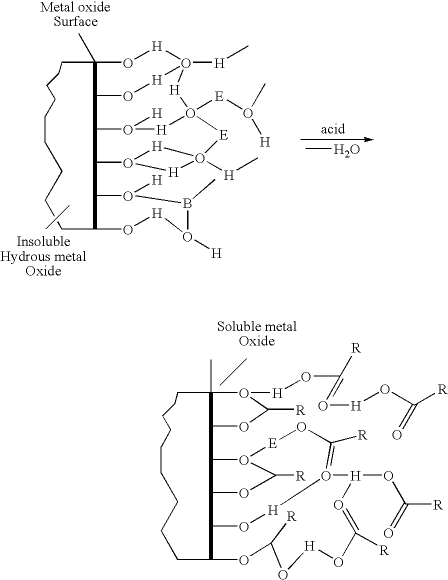

As shown from the above reaction mechanism, the insoluble hydrous metal oxide comprises a number of hydroxyl groups and surface bound water. Addition of the hydrous metal oxide to an organic acid and heating the resultant suspension results in the soluble metal oxide. The soluble metal oxide essentially has the same core as the insoluble metal oxide with the exception that a number of inner and outer organic binding groups have been attached to the metal oxide conferring solubility to the metal oxide.

A Theoretical Model of a Solubilised Tin Oxide Crystallite

The data from thermal, diffraction and spectroscopic techniques can be combined to give a good model of a soluble tin oxide crystallite. Tin oxide crystallises in the tetragonal system with the unit cell parameters a=4.737 Å and b=3.186 Å while x-ray diffraction data point consistently to an average particle size of approximately 19 Å in the case of the soluble tin oxide. Bearing these facts in mind, three model crystallites were developed. This was achieved, in each case, by choosing a unit of structure, a building block, which would have the desired bounding faces of the model crystallite. One building block was the conventional tetragonal unit cell of rutile (tin oxide adopts the rutile structure) while the other two were alternative monoclinic and triclinic cells. The model crystallite was built from a three dimensional assembly of the building blocks such as to give the desired average crystallite size of approximately 19 Å. Important data resulting from the models are in Table 1.

TABLE 1
Data for Idealised Crystallite Particles

| | | | Percent of |
|---|---|---|---|
| | | Ratio of | Surface |
| Average | | Total Tin | Tins with |
| Crystallite | Crystallite | To Surface | Covalently |
| Size (Å) | Faces | Tin | Bound Acetate |
| 19.81 | (1, 0, 0), (0, 1, 0), | 2.24 | 86 |
| | (0, 0, 1) | | |
| 19.68 | (1, 0, 0,), (0, 1, 0), | 1.90 | 73 |
| | (1, 0, 1) | | |
| 20.3 | (1, 0, 0), (1, 1, 0), | 1.78 | 68 |
| | (1, 0, 1) | | |

The data in the final column were calculated based on the fact that the final weight loss in the thermograms is almost entirely resulting from loss of acetate covalently bound to surface tins. In actual fact, none of the models can be considered as perfect models for the crystallites. However, based on the known morphology of tin oxide crystallites it can be argued convincingly that the percentage of surface tins with covalently bonded acetate must be somewhat greater than 68% but is unlikely to be as great as 75%. Furthermore, it can be confidently estimated that the total hydrogen bonded water accounts for less than 5% of the total weight loss on heating to 600° C.

### Example 2

### Preparation of the Soluble Tin Oxide Using Acetic Acid—Comparison between modified additions of Hydrous Tin Oxide and Acid

Preparation

The process as outlined in Example 1 was repeated with the following changes: 55 g of hydrous oxide and 200 cm3 of acetic acid were employed. Otherwise the procedure was identical to that described in Example 1.

Analysis

The carbon content and acetate content were found to be in the same region as the results obtained in example 1. Further analysis showed that greater and lesser quantities of hydrous tin oxide yield substantially the same results as long as there is sufficient acetic acid present to allow a solution to be formed during heating. The x-ray powder diffractometry studies, thermogravimetric analysis and infrared spectra showed similar results to those obtained in Example 1.

### Example 3

### Preparation of Soluble Tin Oxide Using an Acetic Acid/Water Mix Solvent

Preparation

Insoluble hydrous tin oxide was obtained and dried at room temperature as described previously. 10.5 g of the dried insoluble hydrous tin oxide was added to a 100 cm3 90%/10% by volume glacial acetic acid/water mixed solvent (90 cm3) glacial acetic acid/10 cm3 water) to provide a tin oxide suspension. The suspension was stirred for one hour at room temperature and was heated to approximately 85° C. as outlined previously. The solution was filtered and the acetic acid/water mixed solvent was evaporated from the solution to provide the soluble tin oxide in the form of a white solid.

Analysis

Analysis of this soluble tin oxide indicated that it had a lower carbon content than the soluble tin oxide of Example 1 and was in the region of between 7.5% and 8.5%.

The soluble tin oxide was also found to be soluble in cold glacial acetic acid and cold methanol however its solubility in methanol was found to be less than the soluble tin oxide from Example 1.

The further effect of adding water to the solvent was ascertained by preparing a mixed solvent comprising 85% glacial acetic acid by volume and 15% water by volume and repeating the procedure above. Soluble tin oxide was not obtained.

### Example 4

### Preparation of a Soluble Tin Oxide Using Trifluoroacetic Acid

Preparation

Insoluble hydrous tin oxide was obtained and dried at room temperature as described previously. 5 g of the dried insoluble hydrous tin oxide was added to 10 cm3 of trifluoroacetic acid to provide a tin oxide suspension. The suspension was heated to 70° C. and it was noted that the hydrous tin oxide was completely dissolved to give a clear solution. The trifluoroacetic acid was removed on a Rotovap™ to leave a white powder of the soluble tin oxide.

Analysis

The carbon content of the soluble tin oxide was found to be in the range 6% to 6.5%, and the soluble tin oxide was found to have a fluoroacetate content in the range 28.26% to 30.61%.

Solubility

The soluble tin oxide was found to be soluble in methanol, acetone and tetrahydrofuran. For example, the solubility in both acetone and tetrahydrofuran was found to be greater than 1000 g per litre of solvent. The solubility in both acetone and tetrahydrofuran is retained after heating the soluble oxide to 250° C.

X-Ray Powder Diffractometry

The room temperature powder diffraction pattern is identical to that of the soluble tin oxide of Example 1 and particle size, as measured from line width analysis, indicate average particle size of approximately 19 Å. In other words, average particle size is similar to that for the soluble tin oxide which was prepared using acetic acid. Studies of diffraction data for samples heated to various temperatures up to 900° C. indicated that while particle size increases with increasing temperature (sintering process), this increase is not as great as for soluble tin oxide prepared from the acetic acid process.

Infrared Spectroscopy

Where bands associated with υ(C—O) asym. occur in the region 1600-1750 cm.−1, the spectrum of soluble tin oxide exhibits a broad absorption centred at 1696 cm.−1. However, this band has a number of very well defined shoulders to higher and lower frequencies thus indicating different roles of the trifluoroacetate groups. When the sample is heated to 300° C., all but those trifluoroacetate groups which are bound to the tin are removed and the infrared spectrum of this heated sample shows a less complicated spectrum in the 1600-1750 cm.-1 range; two broad overlapping peaks centred at 1640, and 1672 cm.−1. In the 1400 cm.−1 region where bands associated with υ(C—O) sym. occur, a broad weak absorption occurs. The broadness of this band suggests the presence of more than one band. Likewise, two strong bands associated with CF3 rocking occur at 1199 and 1152 cm.−1. Thus, the infrared data point to two types of trifluoroacetate bound directly to tin as is the case for acetate in soluble tin oxide obtained from the acetic acid process.

Further Analysis

The effect of adding water to the trifluoroacetic acid to provide a trifluoroacetic acid/water mixed solvent was ascertained. The mix solvent comprised 50% trifluoroactic acid by volume and 50% water by volume (5 cm3 each respectively) and the procedure was carried out as outlined above. The tin oxide precipitated was found to be insoluble.

Further analysis has also indicated that in the case of this example with the use of trifluoroacetic acid that removal of the outer fluoroacetate group will result in retained solubility of the tin oxide.

### Example 5

### Preparation of a Soluble Tin Oxide Using Propanoic Acid

Preparation

The method of preparation of the soluble tin oxide is directly analogous to that for the process for preparation using acetic acid (Example 1), except that acetic acid is replaced with propanoic acid.

Analysis

Analysis of the soluble tin oxide confirmed the presence of propanoic acid groups. The carbon content was found to be in the range in the range 12-13% and the soluble tin oxide was found to have a propionate content in the range 24.35% to 26.38%. When this form of soluble tin oxide is heated under vacuum for one hour at 100° C., the carbon content reduced to approximately 10.5%, and the propionate content reduced to 21.3%.

Solubility

Soluble tin oxide prepared by this process was found to be soluble in tetrahydrofuran, methanol and in dimethyl-formamide. It was also found to have some solubility in pyridine. Samples heated to 100° C. under vacuum retained their solubility.

Thermogravimetric Data

Thermograms of this form of soluble tin oxide bear similar characteristics of those of soluble tin oxides prepared using acetic acid.

Powder Diffractometry

The powder diffraction pattern of this form of soluble tin oxide is identical to that of the soluble tin oxides prepared using acetic acid revealing a particle size of approximately 19 Å. In the sintering process the powder diffraction patterns reveal that this form of soluble tin oxide behaves essentially identically to the soluble tin oxides prepared using acetic acid

Infrared Spectra

In the important regions 1500-1750 cm.−1 and 1300-1450 cm.−1 the spectra are better defined than those for the soluble tin oxides prepared using acetic acid. Two bands at 1564 and 1623 cm.−1 are attributable to υ(C—O) asym, while a band at 1376 cm.−1 and at approximately 1420 cm.−1 appearing as a clearly defined shoulder are attributable to υ(C—O) sym. These bands are consistent with the presence of monodentate and bidentate propionate groups bound to tin. A sharp band appearing at 1716 cm−1 is attributable to hydrogen bonded propanoic acid molecules. Thus, on the basis of both the thermogravimetric and infrared data, it would appear that the roles of propionate parallel those of acetate in the soluble tin oxides prepared using acetic acid.

### Example 6

### Preparation of a Soluble Titanium(Iv) Oxide Using Acetic Acid

Preparation

Insoluble hydrous titanium oxide was obtained and dried at room temperature until it crumbled into a powder. 6 g of the dried insoluble hydrous titanium oxide was added to 200 cm3 of glacial acetic acid to provide a titanium oxide suspension. The suspension was heated to the boiling point of glacial acetic acid at a temperature in the region of 119° C. and maintained at this temperature for 3 hours. The titanium oxide did not dissolve and was subsequently removed by filtration and dried in air. The remaining acetic acid filtrate was removed using a Rotovap to leave a small quantity of white solid. The X-ray powder diffraction pattern of this white solid indicated that it is not titanium oxide. This insoluble titanium oxide/acetate material was added to glacial acetic acid and the suspension was maintained at reflux temperature for 3 hours. The insoluble titanium oxide was isolated by filtration and dried in air. The acetic acid filtrate in this case was found not to contain any dissolved material.

The insoluble titanium oxide from the above process was added to 200 cm3 methanol and a large excess of 8-hydroxyquinoline was added. A yellow colour immediately was observed in the solution and the undissolved solid also assumed a yellow colour. After refluxing for 4 hours the solution had assumed a deep yellow colour, as also had the undissolved material. The solution was filtered and the methanol of the filtrate was removed on a Rotovap to leave a yellow powder. This powder was repeatedly washed with diethylether and finally allowed to dry at room temperature. An infrared spectrum of this yellow material confirmed the presence of bound 8-hydroxyquinoline and the absence of unreacted 8-hydroxyquinoline. An X-ray powder diffraction pattern of the material confirmed that it was a titanium oxide. This form of titanium oxide was found to be highly soluble in methanol. Solubility is retained, albeit reduced, in samples heated to 300° C. The soluble oxide sintering process was monitored by X-ray diffraction. It parallels the behaviour of hydrous titanium oxide and in the sintering process the yellow colour changes to a red colour and finally the material becomes colourless at 800° C.

Analysis

Analysis of the soluble titanium oxide showed that it had a carbon content of approximately 8%.

### Example 7

### Preparation of Soluble Titanium Oxide Using Trifluoroacetic Acid

Insoluble hydrous titanium oxide was obtained and dried at room temperature until it crumbled into a powder. 1 g of the insoluble hydrous titanium oxide was added to 15 cm3 of trifluoroacetic acid. The resulting suspension was heated to 70° C., at which temperature the titanium oxide had completely dissolved to give a clear colourless solution. The trifluoroacetic acid as described previously was removed to yield a soluble titanium oxide as a white powder.

Analysis

The carbon content of the soluble titanium oxide was 10% thus indicating a fluoroacetate content of 47%.

Solubility

The soluble titanium oxide had excellent solubility in acetone and tetrahydrofuran. (greater than 1500 g per litre in each solvent). This solubility is retained after the oxide is heated to 250° C. Solubility is also good in methanol but precipitation tends to occur after 24 hours (sometimes less).

X-ray Power Diffractometry

The powder diffraction pattern of the soluble titanium oxide clearly indicated that the core structure of the initial hydrous oxide was retained (showing the presence of anatase and brookite phases) following reaction in trifluoroacetic acid. The powder diffraction pattern of a sample of soluble titanium oxide heated to 300° C. indicated increased anatase over the brookite phase and a sample heated to 400° C. gave a powder diffraction pattern indicating total transformation to the anatase phase. The powder diffraction patterns showed a growth in anatase particle size as the temperature was raised to 700° C. However, at this temperature the rutile phase was clearly manifest. The rutile phase become increasing dominant as the temperature was raised to 900° C., at which temperature the anatase phase was a minor component. In overall terms, the soluble titanium oxide behaved similarly to the insoluble hydrous titanium oxide as a result of the heating process.

Thermogravimetric Analysis

A thermogram of the soluble titanium oxide showed the same general features as those found for soluble tin oxide. The most significant difference between the thermograms is that the final steep weight loss which began at approximately 300° C. in the case of soluble tin oxide (derived from acetic acid) began at approximately 250° C. in the case of the soluble titanium oxide.

Infrared Spectroscopy

Analysis of the infrared spectra of samples of soluble titanium oxide recorded for samples which had been maintained at room temperature and for samples heated to temperatures up to 400° C. established the same multiple roles for the hydrogen bonded trifluoroacetic acid and trifluoroacetate covalently bound to titanium as those for the hydrogen bonded acetic acid and covalently bound acetate in the case of soluble tin oxide derived from acetic acid.

As with the other organic binding groups further analysis was carried out to examine the solubility of the metal oxides and in this case titanium oxide when the outer layer of fluoroacetate groups were removed. In contrast to the results shown for the other types of organic binding groups in the case of fluoroacetate groups when the outer organic binding group is removed, the resultant metal oxide with inner fluoroacete groups bound was shown to retain its solubility. This was found to be true for both tin and titanium oxides. Further analysis indicated that even when the outer fluoroacetate groups are removed that the inner fluoroacetate groups remain bonded to the titanium oxide by covalent bonds. Additionally, instead of using trifluoroacetic to provide the fluoroacetate groups, another fluoroacetate providing acid could be used such as monofluoroacetic acid. In this case, it is expected that the resultant soluble titanium oxide would have less fluoroacetate groups bound thereto but would still be soluble.

Therefore, if the acid is a fluorine containing carboxylic acid, (e.g. trifluoroacetic acid) the soluble oxide will have carboxylate groups directly attached to the metal. Providing there is a sufficient number of carboxylate groups attached to surface metal atoms, the oxide can be soluble as a result of the presence of the exposed fluorine atoms. When this level of surface attachment of carboxylate is achieved, further hydrogen-bonded layers can be added which may result in retention of the type of solubility achieved by the presence of the surface carboxylatre groups alone. However, these hydrogen-bonded layers may alter the nature of the solubility.

On the other hand, if the acid is a non-fluorine containing acid (e.g. acetic acid or propionic acid) the soluble oxide has carboxylate groups directly bound to surface metal atoms and further layers of hydrogen bonded acid are built unto the carboxylate/hydroxy surface thus generated. The inner carboxylate/hydroxy layer is not a sufficient condition for solubility. The outer hydrogen bonded layers confer solubility and both the type and degree of solubility is dictated by the nature of the molecules existing in these hydrogen-bonded layers. These latter molecules are not necessarily acid molecules. However, in order to have the necessary outer hydrogen-bonded layers (to confer solubility) an appropriate number of carboxylate groups must be directly attached to the surface metal atoms.

Insoluble hydrous tin(IV) oxide was prepared and dried at room temperature until it crumbled into a fine white powder. 10 g of this insoluble hydrous tin(IV) oxide were added to 100 cm3 of methoxyacetic acid and the resulting reaction mixture was heated to 110° C. upon which it dissolved and a completely clear solution was obtained. Heating was continued to 120° C. for two hours. Following this the solution obtained was allowed to cool to room temperature and then placed on a rotary evaporator where it was rotovaped at 180° C. for one day. Such treatment gave rise to a dry powdery beige material together with a sticky material which was light brown in colour. The dry powdery beige material was soluble tin oxide. The sticky material was repeatedly washed with diethyl ether to remove any excess methoxyacetic acid and to transform the sticky material to a fine beige coloured powder. This resulting powder was also soluble tin oxide and this was allowed to dry in the open air.

Analysis

Analysis of the non-ether washed soluble tin oxide indicated that it had a carbon content of approximately 12%. The ether washed powder had a carbon content of approximately 11.4%.

Solubility

Both the non-ether washed and ether washed samples of soluble tin oxide prepared in the manner described in the above were found to be soluble in methanol and water.

X-Ray Powder Diffractometry Studies

The x-ray powder diffraction patterns of both the ether washed and non-ether washed soluble tin oxide materials are illustrated in FIG. 10. The diffraction patterns of these samples are essentially identical to that of the insoluble hydrous tin oxide indicating that both these materials are bulk tin oxide. The diffraction lines are somewhat sharper than those observed for the insoluble hydrous tin oxide and this is probably due to the fact that these soluble materials were heated to 180° C. for twenty four hours in the course of their preparation; the said heating process giving rise to some crystal growth. Also of note is a slight sharpening of the diffraction lines for the sample of soluble oxide that was ether washed over those of the sample that was not ether washed again indicating a little growth in crystal size on ether washing.

Infrared Studies

The infrared spectra of the ether washed and non-ether washed samples of the soluble tin oxide isolated by reaction of the insoluble hydrous tin oxide with methoxyacetic acid as described in the above are exhibited in FIG. 11 (non-ether washed) and FIG. 12 (ether washed). The presence of methoxyacetate on the surface of these materials is very evident with fairly intense broad absorbtions due to methoxyacetate appearing in a range from approximately 800 cm−1 to 1800 cm−1. The complexity of the absorbtions together with their broadness indicate that methoxyacetate is present on the surface as hydrogen bonded methoxyacetic acid and as coordinated methoxyacetate with the methoxyacetate being coordinated in different modes viz mainly monodentate and bidentate methoxyacetate. There is also a broad, essentially features, envelope apparent from approximately 2200 cm−1 to 3600 cm−1 due to the presence of water and surface bound hydroxyl groups. The only real features noteworthy on this broad envelope are those absorbtions due to νC—H stretching vibrations of the —OCH3 and —CH2 moieties of the methoxyacetate.

The infrared data together with the x-ray diffraction and elemental analytical data indicate clearly that this soluble tin oxide is bulk tin oxide with surface bound methoxyacetate with in addition some surface water and hydroxyl groups.

### Example 9

### Preparation of Soluble Tin Oxide Using Cyanoacetic Acid

Cyanoacetic acid (15 g) was melted in a round bottomed flask over an oil bath. The solid began to melt at approximately 66° C. and the entire solid was completely melted at a temperature of 75° C. Insoluble hydrous tin(IV) oxide (2.5 g) that was previously prepared and dried in open air to a fine white powder was added to this melted acid, in quantities of 0.5 g at a time. The hydrous tin(IV) oxide dissolved with ease and the solution was heated up to a maximum temperature of 95° C. On cooling liquid appeared on the neck of the flask. As the solution cooled it solidified. The resulting solid was repeatedly washed with diethyl ether to remove any unreacted cyanoacetic acid. Infrared spectra, x-ray powder diffraction patterns and thermogravimetric analysis were recorded for the material recovered subsequent to washing with diethyl ether.

Analysis

Analytical data for samples isolated from this experiment indicated a carbon content of 13.49% corresponding to a cyanoacetate content of approximately 32%.

Solubility

Tin(IV) oxide/cyanoacetate was tested for solubility and found only to be soluble in molten cyanoacetic acid.

X-ray Powder Diffractometry Study

The x-ray powder diffraction pattern of the soluble tin oxide isolated from the reaction of cyanoacetic acid with insoluble hydrous tin oxide and then subsequently repeatedly washed with diethyl ether was essentially identical to that of the hydrous tin(IV) oxide and soluble tin(IV) oxide acetate exhibited in FIG. 6 (detailed previously) with an average particle size of approximately 19A indicating this material to be bulk tin(IV) oxide.

Infrared Analysis

The infrared spectrum of the soluble tin oxide isolated from the reaction of cyanoacetic acid with insoluble hydrous tin oxide is exhibited in FIG. 13. It is clearly evident from this spectrum that there is surface bound cyanoacetate. The complexity and broadness of the absorbtions due to cyanoacetate in the region 800 cm−1 to 1800 cm−1 further indicate that the cyanoacetate is bound to the surface by several different modes viz hydrogen bonded cyanoacetic acid and coordinated cyanoacetate, the latter coordinated cyanoacetate being either monodentate or bidentate.

In addition to absorbtion bands due to cyanoacetate there is a broad, generally featureless envelope due to surface water and hydroxyl groups. The only feature noteworthy within this envelope is the absorbtion at 2933 cm⁻¹ due to νC—H stretching vibrations of the cyanoacetate moieties.

The infrared data together with the x-ray diffraction and elemental analytical data indicate clearly that this soluble tin oxide is bulk tin oxide with surface bound cyanoacetate with, in addition, some surface water and hydroxy groups.

Thermogravimetric Analysis

The TGA and corresponding DSC traces for the soluble tin oxide prepared using cyanoacetic acid and described in the above are shown in FIG. 14. There are essentially four temperature regions of weight loss evident in the thermogravimetric trace for this material.

The first of these regions of weight loss (approximately room temperature to 60° C.) is due to the removal of loosely bound or bulk water from the sample. The second is attributable to the removal of more tightly hydrogen bonded or surface coordinated water and occurs from approximately 60° C. to 120° C. The third region of weight loss (approximately 120° C. to 220° C. is probably attributable mainly to a combination of events such as the removal of hydrogen bonded cyanoacetic acid together with some monodentate cyanoacetate and the possible conversion of monodentate cyanoacetate to bidentate cyanoacetate within this temperature range. Beyond 220° C., the weight loss observed from approximately this temperature to approximately 420° C. is attributable to the decomposition of surface coordinated cyanoacetate. There is no significant weight loss observed above approximately 420° C. indicating that essentially all organics have been mostly removed at this temperature.

### Example 10

### Preparation of Soluble Tin Oxide Using Dichloroacetic Acid

Typically 0.5 to 1.0 g of the hydrous tin(IV) oxide was added to 10 cm3 of dichloroacetic acid and was left to stir for 1.5-2 hours at room temperature. The solution, which at first appeared quite cloudy, became completely clear and yellow in colour on stirring with time. Following this, excess acid was removed by rotary evaporation using a silicon oil bath to yield an oil. This oil was washed with diethyl ether to yield a light brown coloured solid. Solubility tests were conducted on the oil and the solid. Infrared spectra, x-ray powder diffraction patterns and thermogravimetric analysis were recorded for all samples.

Analysis

Analytical data for soluble tin oxide samples isolated by way of the preparation described indicated a 5.23% carbon corresponding to a dichloroacetate content of approximately 32%.

Solubility

The soluble tin oxide was tested for solubility as an oil and as a solid. As an oil this material was soluble in methanol, acetone, THF and dichloroacetic acid. However, once reduced to a solid, by washing with diethyl ether, it lost its solubility in methanol and THF but remained soluble in acetone and dichloroacetic acid.

X-ray Powder Diiffractometry Study

The x-ray powder diffraction pattern of the solid obtained on washing the oil obtained with diethyl ether was essentially identical to that of the hydrous tin(IV) oxide and soluble tin(IV) oxide acetate exhibited in FIG. 6 (detailed previously) with an average particle size of approximately 19 Å indicating this material to be essentially bulk tin(IV) oxide.

Infrared Analysis

The infrared spectrum of the soluble tin oxide powder isolated from the reaction of dichloroacetic acid with insoluble hydrous tin oxide is exhibited in FIG. 15. It is clearly evident from this spectrum that there is there is surface bound dichloroacetate. The complexity and broadness of the absorbtions due to dichloroacetate in the region 800 cm−1 to 1800 cm−1 further indicate that the dichloroacetate is bound to the surface by several different modes viz hydrogen bonded dichloroacetic acid and coordinated dichloroacetate, the latter coordinated dichloroacetate being so coordinated in either a monodentate or a bidentate fashion.

In addition to the above there is also observed a broad, essentially features, envelope apparent from approximately 2200 cm−1 to 3600 cm−1 due to the presence of water and surface bound hydroxy groups. Just about apparent within this broad envelope is absorbtion due to νC—H stretching vibrations centered at 2982 cm−1 and this is attributable to the dichlioroacetate moieties present on the surface of the tin oxide.

The infrared data together with the x-ray diffraction and elemental analytical data indicate clearly that this soluble tin oxide is bulk tin oxide with surface bound dichloroacetate with, in addition, some surface water and hydroxy groups.

TGA/DSC Analysis

The TGA and corresponding DSC traces for the soluble tin oxide prepared using dichloroacetic acid and described in the above are shown in FIG. 16. There are essentially one minor three main temperature regions of weight loss evident in the thermogravimetric trace for this material.

The first of these weight loss regions is short with small losses in weight attributable for the main part to the loss of loosely bound water together with some loosely attached dichloroacetic acid. This region of weight loss extends from room temperature to approximately 110° C. The second region of weight loss is quite extensive and extends over the temperature range of approximately 110° C. to 250° C. and is probably attributable, for the main part, to the removal of hydrogen bonded dichloroacetic acid. This is then followed by a weight loss region extending from approximately 250° C. to 350° C. and it is possible that the weight loss observed here is due, for the main part, to the removal of surface coordinated monodentate dichloroacetate by possible decomposition or conversion back to dichloroacetic acid or conversion to bidentate dichloroacetate. The fourth temperature range of weight loss extends from approximately 350° C. to 520° C. and the weight loss here is, for the main part, likely to be due to the decomposition of bidentate dichloroacetate on the surface of the tin oxide. There is no significant weight loss beyond 520° C. and one must consider all organics to have, essentially, been removed at this temperature.

### Example 11

### Preparation of a Soluble Titanium Oxide Using Tartaric Acid

Insoluble hydrous titanium(IV) oxide was prepared and dried at room temperature until it crumbled into a fine white powder. 2 g of this insoluble hydrous titanium(IV) oxide were added to 13 g of tartaric acid previously dissolved in 10 cm3 of water and the resulting reaction mixture heated to 70° C. for twelve hours by which time the titanium(IV) oxide had dissolved and the solution had gone clear. The resulting coloured oil. This oily material was soluble titanium oxide and was not further treated.

Solubility

The soluble titanium oxide obtained by reaction of insoluble hydrous titanium(IV) oxide with tartaric acid as described in the above was tested for solubility in a number of solvents and proved soluble in methanol, ethanol, propanol, ether and glycerol.

### Example 12

### Preparation of a Soluble Titanium Oxide Using Citric Acid

Insoluble hydrous titanium(IV) oxide was prepared and dried at room temperature until it crumbled into a fine white powder. 2 g of this insoluble hydrous titanium(IV) oxide were added to 10 g of citric acid previously dissolved in 10 cm3 of water and the resulting reaction mixture heated to 70° C. for four hours by which time the titanium(IV) oxide had dissolved and the solution had gone clear. The resulting solution was then reduced to dryness on a rotary evaporator and the off-white powder obtained was washed repeatedly with acetone to remove any free or unreacted citric acid together with a crystalline citrate material that had formed as a byproduct of the reaction. On washing with acetone the soluble titanium oxide remained in the form of a pale yellow powder. It did not dissolve in acetone.

Analysis

Analysis of this soluble titanium oxide indicated that it had a carbon content of approximately 24%.

Solubility

The soluble titanium oxide was found to be soluble in water and methanol/water mixtures.

X-Ray Powder Diffractometry Studies

The x-ray powder diffraction patterns of the soluble titanium(IV) oxide materials recorded after various heat treatments are shown in FIG. 17. The diffraction pattern of the sample that was not heat treated is essentially identical to that of the insoluble hydrous titanium oxide. Sharpening of the diffraction lines with increasing temperature of heat treatment indicate crystal growth. The anatase phase is the dominant phase at 400° C. and the rutile phase starts to appear at 700° C. and is the dominant phase at 800° C. and it is the only phase present at 900° C. (the XRD at 900° C. is not shown here). The response of this soluble titanium oxide to heat treatment is essentially identical to that of the insoluble hydrous titanium oxide.

Infrared Studies

FIG. 18 shows a typical infrared spectrum of a non-heat treated sample of the soluble titanium(IV) oxide. The intensity of the bands due to citrate exhibited by this material are weak and quite broad indicating that citrate is present on the surface in several modes both as hydrogen bonded citric acid and coordinated citrate. It may not be so obvious from the diagram presented (FIG. 18) but when the spectrum is expanded out it can be seen that there is also a broad, essentially features, envelope in the approximate 2200 cm−1 to 3600 cm−1 due to the presence of water and surface bound hydroxyl groups. The only features noteworthy on this broad envelope are those absorbtions due to vC-H stretching vibrations of the citrate moieties.

The infrared data together with the x-ray diffraction and elemental analytical data indicate clearly that this soluble titanium oxide is bulk titanium oxide with surface bound citrate together with surface water and hydroxyl groups.

The effect of heat treatment of samples of this soluble titanium oxide at various temperatures is shown in the infrared spectra of FIG. 19. As the temperature of heat treatment is raised there the soluble titanium oxide is stripped of its various types of bound citrate, both hydrogen bonded citric acid and surface coordinate citrate. The absorbtion bands present in the infrared spectrum of the sample at 400° C. are due to citrate that is bound directly to titanium. Infrared analysis reveals that there is complete removal of citrate and its decomposition products on heat treatment of this titanium(IV) oxide/citrate material to 500° C. for two hours.

In addition to the removal of surface bound citrate, water and surface hydroxyl groups are also removed on heating and this is evident from the reduction in intensity of the broad envelope due to these species in the range 2200 cm−1 to 3600 cm−1. This is perhaps most obvious when one compares the spectrum for the sample heat treated at 300° C. shown in FIG. 19 with the spectrum of the non-heat treated sample exhibited in FIG. 2. The former spectrum illustrates the greater prominence of absorbtions due to vC-H stretching vibrations of the citrate moieties. This greater prominence of these absorbtions is due to the removal of water and surface hydroxyl species giving rise to less masking by absorbtions due to these species.

Elemental Data for Heat Treated Samples of Soluble Titanium Oxide

Elemental analytical data were obtained for titanium(V) oxide/citrate at room temperature and after heat treatment to various temperatures for a period of two hours (see Table 2). Indeed such analysis revealed that all traces of organics are removed on heating to 500° C. for two hours and this is consistent with the infrared analysis discussed above.

TABLE 2
Elemental analytical data for titanium(IV) oxide/citrate material
heat treated at the various temperatures indicated.

| Heat Treatment | % Carbon | % Hydrogen | % Nitrogen |
|---|---|---|---|
| Room temperature | 24.13% | 2.45% | — |
| 200° C. for 2 hours | 22.73% | 2.99% | — |
| 300° C. for 2 hours | 18.86% | 1.49% | — |
| 400° C. for 2 hours | 4.39% | 0.54% | — |
| 500° C. for 2 hours | — | — | — |
| 600° C. for 2 hours | — | — | — |

Thermogravimetric Analysis

A typical thermogram together with the corresponding DSC trace of a soluble titanium(IV) oxide material obtained by preparation using citric acid is illustrated in FIG. 19. It is noteworthy that loss in weight is still being observed via the TGA trace up to and including 600° C. This is the upper limit of the TGA/DSC equipment available and TGA/DSC traces could not be observed beyond this.

Notwithstanding the fact that weight loss is still being observed at 60° C. in the course of TGA/DSC analysis it is possible, in the course of heat treatments in a furnace, to remove all traces of organic material by heat treatment at lower temperatures for extended periods of time. It must be remembered that the TGA/DSC traces record events occurring within and on the surface of the material on increasing temperature under a steady stream of nitrogen whereas in the annealing process these materials are being heat treated in an air atmosphere. So thus while weight loss from this titanium(IV) oxide/citrate material is still being observed at 600° C. in the TGA trace, elemental analysis (see Table 1) together with infrared data (FIG. 19) of this material annealed in a furnace for two hours at 500° C. indicate that the surface is free of organic moieties.

### Example 13

### Control of Solubility of the Metal Oxide by Surface Group Removal and Replacement

As outlined above, the acid used determines the organic binding groups. Thus when acetic acid is used the outer organic binding group is an acetate, when trifluoroacetic acid is used the outer organic binding group is a fluoroacetate group, and when propanoic acid is used, the outer organic binding group is a propionate group. As discussed in the previous examples the different organic binding groups confer different levels of solubility to the metal oxide in different solvents.

It is further possible to modify the type of solubility of each soluble metal oxide. (a) Modification of acetate bound soluble tin oxide to provide fluoroacetate bound soluble tin oxide. Soluble tin oxide having acetate groups as organic binding groups was prepared as in Example 1. 2 g of the soluble tin oxide was heated to 300° C., at which temperature it became insoluble. The insoluble tin oxide was added to 10 cm3 trifluoroacetic acid and the suspension was heated to 100° C. After 10 minutes at this temperature, the previously suspended material was totally dissolved to give a clear solution. The trifluoroacetic acid was removed by a Rotovap™ to give a soluble tin oxide that now had solubility in methanol, tetrahydrofuran and acetone. In other words, the resultant soluble tin oxide now behaved like soluble tin oxide prepared using trifluoroacetic acid. (b) Modification of fluoroacetate bound soluble tin oxide to provide acetate bound soluble tin oxide. 2 g of soluble tin oxide having fluoroacetate groups as organic binding groups was prepared as in Example 4 and was heated to 300° C. at which temperature it became insoluble. The insoluble tin oxide was added to 50 cm3 acetic acid and the suspension was heated to 100° C. After 10 minutes at this temperature, the material was totally dissolved to give a clear solution. The acetic acid was removed by a Rotovap™ to give a soluble tin oxide that was soluble in methanol but not tetrahydrofuran or acetone. In other words, the resultant soluble tin oxide had the solubility characteristics of soluble tin oxide prepared using acetic acid. The infrared spectrum of this material show that trifluoroacetate groups remain bonded to tin. (c) Modification of acetate bound soluble tin oxide to provide propionate bound soluble tin oxide. 2 g of soluble tin oxide having acetate groups as organic binding groups was prepared as in Example 1 and was heated to 300° C. at which temperature it now became insoluble. The insoluble tin oxide was added to 50 cm3 propanoic acid and the suspension was heated to 120° C. After 10 minutes at this temperature, the material was totally dissolved to give a clear solution. The propanoic acid was removed using a Rotovap™ to give a soluble tin oxide that was soluble in methanol, tetrahydrofuran and acetone. In other words, the resultant soluble tin oxide now had the solubility characteristics of soluble tin oxide prepared using propanoic acid. (d)Modification of acetate bound soluble tin oxide to provide phosphate bound soluble tin oxide. 2 g of soluble tin oxide having acetate groups as organic binding groups was prepared as in Example 1 and dissolved in 30 cm3 of methanol. Concentrated phosphoric acid was slowly added at room temperature and the resulting solution stirred at room temperature for 10 minutes. The molar quantity of phosphoric acid was confined to be in the region of 100th of the molar quantity of tin present. The methanol was removed on a Rotovap™ to leave a colourless material. The infrared spectrum of this material confirmed the presence of both acetate and phosphate; not free phosphoric acid. An X-ray powder diffraction of the material confirmed the retention of the tin oxide rutile structure. This material had excellent solubility in methanol (similar to that of the soluble tin oxide prepared using acetic acid) but furthermore, it also had excellent solubility in water. The phosphate-modified material gave perfectly stable aqueous solutions. (e) Modification of acetate bound soluble tin oxide to provide phenylphosphonate bound soluble tin oxide. 2 g of soluble tin oxide having acetate groups as organic binding groups was prepared as in Example 1 and was dissolved in 40 cm3 of methanol. Phenylphosphonic acid dissolved in 10 cm3 methanol was added dropwise to the soluble tin oxide—methanol solution over a period of 10 minutes (the tin:phenylphosphonic acid molar ratio was 10:1). After stirring for a half hour at room temperature, the methanol was removed by a Rotovap™. The remaining white solid was repeatedly washed with acetone to remove unreacted phenylphosphonic acid. The infrared spectrum of the washed white material showed the presence of both phenylphosphonate and acetate and further confirmed the absence of unreacted phenylphosphonic acid. A powder diffraction pattern confirmed the retention of the tin oxide rutile structure. This form of soluble tin oxide has very good solubility in methanol. (f) Modification of acetate bound soluble tin oxide to provide 8-hydroxyquinoline bound soluble tin oxide. 2 g soluble tin oxide having acetate groups as organic binding groups was prepared as in Example 1 and was dissolved in 100 cm3 of methanol. Solid 8-hydroxyquinoline was added in large excess to give a bright yellow solution. After stirring for a half hour at room temperature, the methanol was removed by a Rotovap™. The remaining yellow solid was repeatedly washed with diethylether to remove unreacted 8-hydroxyquinoline. The diethylether contained unreacted 8-hydroxyquinoline. The infrared spectrum of the washed yellow material showed the presence of both bound 8-hydroxyquinoline and acetate and further confirmed the absence of unreacted 8-hydroxyquinoline. A powder diffraction pattern confirmed the retention of the tin oxide rutile structure. This form of yellow soluble tin oxide has very good solubility in methanol. (g) Modification of acetate bound soluble tin oxide to provide polyethylene glycol 4000 bound soluble tin oxide. 0.75 g of soluble tin oxide having acetate groups as outer organic binding groups was prepared as in Example 1 and was dissolved in 25 cm3 of methanol to provide a solution. To the solution of soluble tin oxide in methanol was added an amount of the solid polyethylene glycol such that the tin/polyethylene glycol molar ration was 1/1. The solution was refluxed for two hours, after which time the solvent was removed on a rotovap. This yielded an oily material which was found to be not only soluble in methanol, but also extremely soluble in tetrahydrofuran. An infrared spectrum of the oily material confirmed that the polyethylene glycol was bound to the tin oxide crystallites. Rather surprisingly, the tetrahydrofuran soluble tin oxide was not generated by the attempted reaction of the soluble tin oxide with the polyethylene glycol in tetrahydrofuran.

### Example 14

### Formation of Soluble Mixed Metal (Doped) Oxides

The soluble tin and titanium oxides, when in solution, react readily with metal powders in a redox reaction which results in the reduction of the oxidation state of metal sites within the oxide and the incorporation of metal ions from the metal that has undergone oxidation. This is readily done without loss of solubility. The metal powder used in the redox reaction can be the same as the metal of the metal oxide but alternatively it can be a different metal. a) 0.7 g of soluble titanium oxide following trifluoroacetic acid treatment (i.e. prepared by the process of example 7) was heated to 200° C. for two hours in order to reduce the quantity of hydrogen-bonded trifluoroacetic acid. The oxide was subsequently dissolved in 50 cm3 acetone. Approximately 1.0 g of indium metal powder was added and the acetone was refluxed for approximate two hours. Over this period the colourless solution of the titanium oxide underwent colour changes to yellow, turquoise and finally a deep sky blue. At this stage the remaining indium, which had fused into a solid shiny lump, and was removed. When the solution was exposed to air, the blue colour rapidly faded to yield a pale yellow colour (resulting, to an extent, to the presence of the indium ions chemically attached to the titanium oxide surface). When the experiment was carried out in a nitrogen atmosphere, the blue colour of the solution was retained and a bluish green solid isolated following removal of solvent by distillation. This coloured oxide retained excellent solubility and gave a powder diffraction pattern that confirmed the retention of the titanium oxide structure.

Identical experiments to that in (a) were carried out, using tin and zinc powders in place of indium, resulting in the formation of bluish green solutions. The coloured oxides recovered from these redox reactions retained their solubilities and also retained the titanium oxide structure. A 0.75 g sample of soluble tin oxide from the acetic acid treatment (as prepared by the process of example 1) were heated to 120° C. for two hours, after which time it was dissolved in 60 cm3 methanol. Approximately 1.0 g of indium metal powder was added and the methanol brought to reflux temperature for two hours. Over this period a deep yellow colour developed in what had been a colourless tin oxide solution indicating the presence of indium ions in the oxide lattice. After removal of the excess indium the methanol was removed on a rotovap to leave a yellow solid. This solid retained the solubility and rutile structure of the original tin oxide.

Identical experiments to that in (c) using tin, antimony and zinc powders, also yielded yellow solids (orange yellow in the case of the product obtained from reaction of tin oxide with tin metal). The yellow doped tin oxides retained the solubility and rutile structure of the original tin oxide.

Identical experiments to that in (c) using manganese and cobalt metals yielded golden brown and deep purple solutions respectively, from which deep brown and purple tin oxide products respectively were recovered. These doped mixed metal oxide samples also retained the solubility and rutile structure of the original tin oxide. 0.75 g of soluble tin oxide from trifluoroacetic acid treatment were dissolved in 50 cm3 tetrahydrofuran. After adding approximately 1.0 g manganese powder, the tetrahydrofuran solution was brought to reflux temperature for two hours. Even before reflux temperature was attained, the colourless solution had acquired a brown orange colour and after two hours refluxing the colour had considerably intensified to a rich red brown solid. After filtering the rich red brown solutions to remove unreacted manganese followed by removal of the solid under reduced pressure a brown solid was obtained. An x-ray powder diffraction pattern of the brown solid confirmed that it had the rutile tin oxide structure. The doped oxide retained the original solubility in acetone, tetrahydrofuran and methanol and furthermore, very good solubility was extended to diethyl ether and ethyl acetate.

### Example 15

### Extraction of Tin from a Mixed Tin, Antimony and Iron Ore

A mixture of the hydrous oxides of tin, iron and antimony were obtained by dissolving an ore in a mineral acid to form a mineral acid solution comprising aqueous tin, antimony and iron species. The pH of the solution was increased to form hydrous tin, antimony and iron oxides within the solution and to precipitate the hydrous tin, antimony and iron oxides from solution. A mixture of the hydrous oxides of tin, antimony and iron was added to excess acetic acid and the mixture brought to reflux temperature for three hours. After this time the solution was cooled to room temperature and filtered. This removed the hydrous antimony oxide completely along with a large proportion of the iron oxide. The filtrate was reduced to dryness to give a solid that was dissolved in methanol. The solution was allowed stand for more than 24 hours. At this time a red precipitate had formed and the solution was colourless. The red solid was removed by filtration and the solvent removed to yield the soluble tin oxide.

### Example 16

### Soluble Tin Oxide Acting as a Homogenous Catalyst: Tin Oxide Catalysed Urethane Formation

A reaction between phenyl isocyanate and butanol was followed by monitoring the loss of intensity of the isocyanate vnco band at 2261 cm −1 in the infrared spectrum of phenyl isocyanate (see R. P. Houghton and A. W. Mulvaney, J. Organometal. Chem., 1996, 518, 21). Three separate tetrehydafuran solutions A, B, and C were prepared. A and B contained equimolar quantities of phenyl isocyanate and methanol. In addition, A also contained a catalytic quantity of soluble tin oxide prepared as in example 4. Solution C contained isocyanate and soluble tin oxide prepared as in example 4. All three solutions were heated to 40° C. for one hour. At the end of this period, solutions B and C exhibited the vnco band at 2261 cm −1 without having undergone loss of intensity. By contract, the band had completely disappeared from the spectrum of the solution A, (the flask containing all three components) thus demonstrating the catalytic formation or urethane.

Characteristics of Films

According to the invention, there is provided a metal oxide film formed from the metal oxide solution as described above. According to the invention there is further provided a mixed metal oxide film formed from a mixed metal oxide solution as described above. These films have particular characteristics as set out below.

The tin (iv) oxide particles and tin (iv) oxide acetate material were prepared as described in examples 1-5, the titanium (iv) oxide particles were prepared as described in example 6 and the tin (iv) trifluoroacetate materials were prepared as described in example 8.

Uniformity of Particle Size

The size and morphology of metal oxide particles were obtained from TEM imaging of these materials deposited on carbon coated copper grids. FIGS. 20a and 20b below illustrates these images for the Tin(IV) oxide material magnified to 30 k (a) and 200 k (b). These images reveal highly dispersed clusters of nanoparticles with a very narrow range of particle size of the order of 5 to 10 nm in diameter. This type of narrow particle size distribution is the one preferred in coatings. A wide particle size distribution would indicate non-uniformity of coating and less control over particle size in the coating process. FIG. 20 shows TEM images of SnO2 nanoparticles magnified, FIG. 20(a) shows a magnification of 30 k times and FIG. 20(b) shows a magnification of 200 k times. It should be noted that coating solutions were just dropped onto the copper grids and the resulting deposits allowed to air dry at ambient temperature, no annealing steps were employed.

Uniformity of Doping

Doping of the soluble Tin(IV) oxide or Titanium(IV) oxides with metals by way of either doping with the powdered form of the metal or doping by way of photolysis of metal carbonyl gives rise to metal doped oxides in which the doping is very uniform throughout. For example FIG. 21 illustrates an x-ray photoelectron depth profile analysis of manganese doped tin(IV) oxide acetate. FIG. 21 shows a graph of the XPS depth profiling analysis of a coating of Tin(IV) oxide doped with manganese on silica coated glass. From this profile it can be seen that as one etches through the film adhered to the glass surface the ratio of Sn:Mn is fairly constant throughout with tin content at approximately 37% plus manganese at approximately 3%. After approximately 35 minutes of etching through the surface with fast atoms of argon the probe reaches the silica surface. As it approaches this point both the tin and manganese contents decrease simultaneously and very rapidly and the silicon content is observed to increase rapidly as the XPS is seeing the silicon content of the SiO2 coating. In conjunction with this event there is an observed decrease in atomic percentage oxygen consistent with the greater oxygen content of the Tin(IV) oxide coating over the silica coating. Subsequent to this the glass constituents (O, N, Na, Ca and Mg) are observed as the etching process finally reaches the actual glass surface.

Surface Roughness Factors

Tin(IV) oxide surfaces obtained by coating using chemical vapour deposition and other deposition methods generally exhibit a considerable degree of roughness with roughness factors (Ra) of the order of 8-10 nm and sometimes much greater. However, coatings obtained by spin coating or dip coating with soluble Tin(IV) oxide acetate, or Titanium(IV) oxide trifluoroacetate exhibit surfaces of hitherto unparalleled smoothness.

Table 3 provides roughness data for Tin(IV) oxide surfaces prepared by dip coating glass samples in a solution of Tin(IV) oxide acetate in methanol. These data were obtained by imaging using Atomic Force scattering spectroscopy in tapping mode. The images obtained were compared with samples of typical Tin(IV) oxide coated surfaces used on an industrial scale for plate glass.

TABLE 3
Roughness Analysis of Tin(IV) Oxide
Films Produced by Dip Coating

| | Scan size | Ra | Rmsa | Z-range |
|---|---|---|---|---|
| Sample | (μm × μm) | (nm) | (nm) | (nm) |
| SnO2 Surface using | 1 | 0.42 | 0.53 | 4.61 |
| Soluble Tin(IV) Oxide | | | | |
| | 0.5 | 0.35 | 0.44 | 3.48 |
| | 5 | 0.38 | 0.49 | 6.63 |
| Typical SnO2 surface | 20 | 10.19 | 44.75 | 898.86 |
| | 5 | 0.97 | 1.5 | 45.51 |
| | 5 | 1.16 b | 2.96 b | 84.79 b |

a Rms = Root Mean Square;
b This sample was the same as the one above it in the table but with a new tip employed in the course of the analysis.

The film obtained by dip coating with Tin(IV) oxide acetate showed very little surface structure, and consisted of very fine grains. The roughness factors observed are very low and indicative of an ultra-smooth surface the quality of which is unprecedented. This sample was imaged over three different sized areas (5 μm×5 μm, 1 μm×1 μm and 0.5 μm×0.5 μm area) and FIG. 22 illustrates the actual images obtained for these scans together with a colour scale indicating the surface smoothness and its distribution over the sample. These measurements indicate roughness factors (Ra values) of the order of 0.38 nm over a 25 μm2 area down to 0.35 nm over an area of 0.25 μm2 (Table 3).

FIG. 22 shows Atomic Force Spectroscopy images of SnO2 coatings obtained from dip coating a glass sample with soluble tin(IV) oxide acetate. It can be seen from the height above surface colour guide to the above illustrated images that these heights show little variation and are found in the narrow range of approximately 2-4 mn even over the largest area scanned (25 μm2).

As previously stated a Tin(IV) oxide coating more typical of the SnO2 surfaces encountered on plate glass and laid down by chemical vapour deposition was examined in conjunction with the coating produced by the present invention so as to obtain a direct comparison between the two technologies. This latter sample was imaged over two different sized areas (20 μm×20 μm and 5 μm×5 μm area) and the images obtained from these Atomic Force Microscopy scans are illustrated in FIG. 23.

FIG. 23 shows Atomic Force Spectroscopy images of SnO2 coatings obtained for typical Tin(IV) oxide coatings on plate glass. The 20 μm×20 μm area images (FIGS. 23A and 23B) provide low magnification views of the surface and it can be seen from these views that there are quite a number of large rough deposits on the surface of this film. In addition to these large deposits the overall surface is seen as somewhat striated. Over this sized area the overall roughness factor with an Ra value of 10.19 nm (Table 3). From the accompanying colour guide to height above the surface it can be seen that the large particulates reach heights of the order of 50 nm and it is these particulates that give rise to the large roughness values.

FIGS. 23C and 23D provide closer up views (5 μm×5 μm) of this typical tin(IV) oxide coating together with colour coded height profile measures. These views exclude the large deposits seen in FIGS. 23A and 23B and roughness factors calculated for these areas are specific for these areas and do not include the rough deposits seen in the broader views. Nonetheless the roughness factors are still large with a Ra value of 0.97, almost three times that of the Ra value for the coating generated using the soluble Tin(IV) oxide acetate as the coating material. It should be pointed out that, such is the roughness of this film that it repeatedly blunted the tip of the AFM probe. This did not occur with the film produced using the present invention. The image shown in FIG. 23(C) is one obtained from the same coating as in FIG. 23(D) but with a new AFM tip being employed during the scan.

FIG. 24 provides a direct comparison of the nature of the surface of films obtained using the present invention and those obtained using the prior art. FIG. 24 makes a direct comparison of the surface smoothness of Tin(IV) oxide coatings obtained from the Present invention(A) and a typical industrial Tin(IV) oxide Coating (B). This figure illustrates the dramatic difference between the smoothness of films produced by comparing equal surface areas (25 μm2) of the two coatings. FIG. 24A illustrates the ultra-smooth coating obtained by dip coating the glass substrate in a methanolic solution of tin(IV) oxide acetate and subsequently annealing the film obtained. As pointed out the roughness factor (Ra) for this coating is only 0.38 nm with height measurements in the region 2-4 nm. There are no large conglomerates produced on the surface in the course of this coating technique. FIG. 24B illustrates a typical tin(IV) oxide coating obtained by way of chemical vapour deposition and this contrasts markedly with the former coating, exhibiting an Ra value of 0.97 nm and height parameters ranging from 4-10 nm. In addition this typical oxide coating did evidence the formation of large rough deposits when viewed at lower magnification (see FIG. 24 in the above).

Elasticity and Plasticity

The elastic modulus or Young's modulus of a typical coating obtained using the present invention was measured using a nano hardness tester in conjunction with atomic force microscopy. A typical load displacement curve obtained in the course of these studies is shown in FIG. 25. FIG. 25 shows a Load/Displacement curve for nanoindentation of 440 nm tin oxide film on silicon substrate, where the maximum load is 1 mN using an approach speed of 2000 nm/min. After initial contact of the nano indenter on the surface the load is increased at a predefined rate to the desired maximum and then decreased, at the same rate to zero. The unloading curve follows the partial elastic recovery of the sample material, and it is this phenomenon that allows the derivation of information on elastic modulus.

Using these load displacement curves Young's modulus was determined to be of the order of 62 GPa and to put this into perspective a typical value for Young's modulus for glass itself is in and around 69 GPa while that for diamond like carbon (DLC) is 70 GPa. So thus these coatings do have some elasticity and this is further evidenced in the actual curve depicted in FIG. 25 where the maximum penetration depth of the nano indenter is approximately 110 nm while the final depth is circa 90 nm. A perfectly elastic material would undergo complete recovery to a final depth of zero.

FIG. 26 illustrates a high magnification image of the indent created in a typical Tin(IV) oxide coating using the nano indenter. The elastic and plastic properties of the material are clearly identified from this image.

The fact that there is an impression left on the sample is due to the plastic property and this plastic property of these coatings is manifest in the load-displacement curve illustrated in FIG. 26. A perfectly plastic material would have the unloading part of the curve coming vertically downwards after the indenter is removed and the maximum and final depth would be equal. These coatings are not perfectly plastic with the final depth being less than the maximum depth but the unloading part of the curve does indicate that the films do have some plasticity.

The elasticity or recovery is identified in the image (FIG. 26) by the fact that the walls of the indent curve inwards. FIG. 26 shows a high magnification image of the indent created in a typical Tin(IV) oxide coating. The AFM analysis also showed that the coating did not break or crack with the load. If a material cracks or delaminates with indentation distortions around the edges of the image are observed and this is clearly not happening in this case, despite the fact that the indenter penetrated deeply into the film.

FIG. 27 shows a 3D image of the indent and it is noteworthy from this image that there is no pile-up of material evident on impact by the nano indenter. Pile-up is identified by the material displaced by the indenter being pushed to the sides of the imprint, or if it is compressed into the bulk it is called ‘sink-in’. It is clear from this image that pile-up is not an issue with these tin oxide films.

For coated systems and in particular for soft films on hard substrates pile-up is significant because of the constraint the substrate exerts on the deformation of the film. This image reveals that these coatings are tough and robust.

Adhesion Properties

The adhesion of a coating to a substrate or the possible delamination of a coating from a substrate are critical factors in deciding on a particular use or application for a coated material. This is particularly important in the areas of medical devices and medical implants.

The adhesion properties of coatings, produced by way of the present invention, were investigated using a nano scratch tester. Results of these tests for silicon samples coated with a film of 400 nm of tin oxide were compared to a silicon sample coated with ˜100 nm diamond like carbon (DLC).

The comparison with DLC is appropriate as these latter films are recognised for having excellent mechanical, tribological and biological properties. DLC coated cardiovascular implants are commercially available and research is ongoing with these films particularly in the area of orthopaedic implants.

The results from a scratch test performed on the tin oxide coating on silica from 0.1 to 50 mN are shown in FIGS. 28A and 28B. The delamination of the film is marked by where the green lines go from straight to turbulent. This region on the graph is aligned with the delamination on the optical image of the film. The load at the point of delamination is read from the graph. The tin oxide film delaminated at a load of ˜7.5 mN. The DLC film of 100 nm on silicon delaminated at about 12 mN. FIGS. 39A and 39B show the details for the delamination of the DLC coating.

The code for understanding the graphs is as follows: Top horizontal trace—residual depth; Top trace with negative slope—penetration depth; Bottom trace with positive slope—force; Horizontal trace second from bottom—friction coefficient; Bottom horizontal trace—friction force.

FIG. 28(b) show the nano scratch results on Si sample with 400 nm film of tin oxide. The point of delamination on the graph is matched to that on the image and the delamination force is read at that point. Tin oxide delaminated at ˜7.5 mN. The first optical image is showing that the film is scratched but not broken, the second image shows the film has just delaminated and the result is the force applied when that happened. The third image is showing that the coating has been broken and that the substrate is now being scratched.

This is compared to the DLC film, the details of which are shown in FIGS. 29A and 29B. The load to delaminate this film was ˜12 mN. The first of the two optical images (FIG. 29B) shows the film is scratched the second of the two shows that the film has been delaminated.

FIG. 29B shows the nano scratch results on Si sample with 100 nm film of DLC. The point of delamination on the graph is matched to that on the image and the delamination force is read at that point. In this case the load to delaminate the film was ˜12 nm.DLC is a very hard material and the result from the tin oxide film showed that it compared very well to the DLC in terms of adhesion to the silicon substrate.

Porosity of Coatings

When stainless steel is coated using solutions of titanium(IV) oxide trifluoroacetate in organic solvents and subsequently annealed the temperature of annealing determines the nature of the surface obtained. At low temperatures crystallinity is low and titanium (IV) oxide exists on the surface in both anatase and brookite phases. As the temperature of annealing is raised crystal growth occurs together with the development of pores. FIG. 30(A) and FIG. 30(B) illustrate a typical titanium (IV) oxide coating, obtained by spin coating a coupon of stainless steel with titanium (IV) oxide/trifluoroacetate and then annealing to 800° C. for three hours. These images show the highly crystalline nature of the titanium (IV) oxide on the surface together with the high degree of porosity that has developed as a result of annealing at this temperature.

This porosity as depicted (FIG. 30) renders these coatings suitable for the absorbtion and sustained release of drugs, dyes, pesticides, insecticides, and fragrances.

Surface Integrity

Quality abrasion tests were performed on a coating of titanium(IV) oxide on a stainless steel substrate using a stainless steel tip in order to evaluate the mechanical quality of this coating. FIGS. 31 (a) and (b) show the abrasion made in the surface and reveal excellent mechanical quality with no flaking or partial removal of the coating being evident in the vicinity of the abrasion. FIG. 31 provides a plan view SEM micrographs at (a) low magnification and (b) high magnification of the scratch onto one coating of titanium(IV) oxide on a steel substrate that was annealed at 400° C. for 3 hrs.

A surface integrity challenge was carried out on a sample coating of titanium(IV) oxide on a stainless steel substrate prepared by way of the present invention using a solution of titanium(IV) oxide trifluoroacetate in pentan-3-one (100 g/L) and annealing at 800° C. for 24 hours. An abrasion was made on the surface of the coating using a stainless steel tip and the steel coupon was subsequently put through a series of bends with scanning electron microscopic analysis of the area containing the abrasion being conducted on the occasion of each bend.

FIGS. 32(A) and (B) to FIGS. 35(A) and (B) illustrate the bends employed together with the scanning electron micrographs obtained on bending. FIGS. 32(A) and (B) shows a Surface Integrity Challenge of Titanium(IV) oxide coating on stainless steel with a 30 degree bend along abrasion. FIGS. 33(A) and (B) shows a Surface Integrity Challenge of Titanium(IV) oxide coating on stainless steel with a 45-50 degree bend along abrasion. FIGS. 45(A) and (B) shows a Surface Integrity Challenge of Titanium(IV) oxide coating on stainless steel with a 60-70 degree bend along abrasion. FIGS. 35(A) and (B) shows a Surface Integrity Challenge of Titanium(IV) oxide coating on stainless steel with a 80-90 degree bend along abrasion.

It is clear from these images that the titanium(IV) oxide coating is very well adhered to the stainless steel substrate, is extremely robust with no tendency towards cracking, peeling, flaking or splintering even on being bent through an angle of 90° [FIGS. 35(A) and (B)]. So thus these titanium oxide coatings possess quite a degree of flexibility and elasticity consistent with the findings for the tin(IV) oxide coatings which were found to have a Young's modulus of 62 GPa.

These abrasion tests are of great importance in the area of medical implants where cracking, flaking or splintering of the coated device would not be a desired feature and may indeed prove fatal. Of particular interest is the use of these coatings on stents and such flexibility as observed would be prerequisite given the method of implantation of the stents and further the wear and tear to which they would likely be subjected to by blood flow. Indeed these tests indicate that this coating technology is very well suited for the coating of stents and were very much carried out with these in mind.

Lateral Growth

The most unique feature of the tin(IV) and titanium(IV) oxide films produced by the present invention is the fact that on calcination these films undergo lateral growth. Such lateral growth as seen in the films examined is unprecedented anywhere in the literature and films laid down by numerous techniques including CVD invariably undergo columnar growth in the z-direction i.e. perpendicular to the plane of the coating. Some authors have alluded to lateral growth in films when the growth direction was not exactly vertical but this would more correctly be described as angular or diagonal growth and this is very much evidenced from the scanning electron micrographs exhibited by the authors where the crystal growth is clearly columnar albeit slanted or dipped towards the horizontal. In contrast to these micrographs FIG. 36 exhibits a high magnification images of a tin(IV) oxide film on silica coated glass and here it can be seen that crystal growth is distinctly linear. These images taken at an 80° tilt and 90° cross section when examined closely reveal the bead like nature of the tin(IV) oxide particles on the edge of the film and particularly at the foot of the film. These bead like particles could only arise as result of lateral growth.

Similar observations are made from micrograph images of titanium(IV) oxide films on silica coated glass, the films again being produced by the present invention. FIG. 38 illustrates the nature of the films obtained from an 80° tilt and a 90° cross section and again the bead or pebble like particles can clearly be seen at the base of the film's edge. Indeed these images in both FIGS. 36 and 37, in addition to exhibiting unique lateral growth illustrate the uniformity, density, consistency and ultra-smoothness of the films obtained. These latter attributes of these films are as a direct result of lateral growth.

In all coatings analysed lateral growth was favoured above all other methods of crystal growth. The growth of crystallites, whether from a layer of single or multilayer coatings, is parallel and not perpendicular to the substrate as would be expected.

It is known that film morphology such as surface aspect or preferred orientation is strongly influenced by the chemical nature of the precursors used in laying down the film. In the present study tin(IV) oxide films were produced by spin coating with a methanolic solution of tin(IV) oxide acetate while titanium (IV) oxide coatings were produced by the same method using acetone based titanium(IV) oxide trifluoroacetate.

Low Coefficient of Friction

It is the very smoothness of these coatings generated using the present invention and observed directly in the course of the present study that render them most suitable in the coating of medical implants and devices and further in the coating of moving parts of engines and machinery. Consistent with the ultra smooth nature of these coatings is the fact that compared to stainless steel the coefficient of friction is reduced by a factor of approximately one sixth for example on coating the steel with tin(IV) oxide using the present invention. This reduction of coefficient of friction on coating with these materials and in particular on coating with titanium(IV) oxide further renders these materials suitable in the coating of medical devices and particularly in the coating of stents where there may be a tendency for the stainless steel stent to slow blood flow and increase the risk of clotting.

Applications of the Coatings

Use of SnO2 thin films as spacer layers in Metal Enhanced Fluorescence (MEF) sensing platforms.

Tin(IV) oxide thin films can be used as a spacer layer to provide sufficient spacing between the metallic structure and the fluorophore to prevent quenching of the fluorescence. The Metal Enhanced Fluorophore will comprise a fluorophore, a metallic structure and a spacer layer, wherein the spacer layer comprises a Tin(IV) oxide film and will provide for enhanced fluorescence of weak fluorophores as a result of their interaction with the sub-wavelength metallic structures.

### Example 17

In this work thin films of tin(IV) oxide derived from soluble tin(IV) oxide acetate have been used as ‘spacer layer’ between silver island films (SIF) and Rose Bengal (a low quantum yield fluorophore) in MEF sensing platforms. SnO2 film thickness, estimated both by ellipsometry and reflectivity, as low as 7.77 nm was achieved allowing the use of these novel thin films as ‘spacer layers’. More than 5-fold fluorescence enhancement was subsequently achieved for substrates coated with silver island films and SnO2 thin films, using Rose Bengal as model fluorophore.

Subsequent to individual preparation and characterisation of silver island coatings and SnO2 thin films, MEF sensing platform incorporating these individual layers were prepared and characterised. Solutions of Rose Bengal were pipetted onto half silver coated substrates. 120 μm Secure Seal™ Imaging Spacers were used to hold the Rose Bengal solution. Half the solution was held on the silver-coated side, while the other half was held on the uncoated side of the microscope slide. This allowed for fluorescence analysis of the Rose Bengal on or off the silver coating on the same glass slide and these will be referred to as the ON and OFF sides of the sensing platform respectively. A clear microscope glass was then pressed against the imaging spacer in order to secure the sensing platform (see experimental section for further details). FIG. 39 shows the Rose Bengal OFF and ON SIF fluorescence intensity. Strong ON fluorescence intensity signals can be seen in FIG. 29 for both non-annealed and annealed samples. Enhancement values of 4.30 and 5.43, measured using the integrated area under the curves in FIG. 39, were achieved for SIF+SnO2 and SIF (annealed)+SnO2 samples respectively. These results are very promising since they are better than results previously reported.

With regard to the coatings employed in the course of this study FIG. 40 shows the UV-VIS absorption spectra of (a) Silver Island Film (SIF), (b) SIF(annealed), (c) SIF(annealed)+SnO2 coated substrates. Both a decrease in the surface plasmon resonance and a red shift was observed for the SIF(annealed) sample, suggesting that larger particles were formed during the annealing of this film. Following SIF coating, a 10 nm SnO2 thin film was deposited onto the SIF coated substrate by spin-coating. This thin film of tin(IV) oxide gave rise to a further decrease in the silver plasmon band and this is evident in the UV spectrum of this SnO2 ‘spacer layer’ sample. Such a spectral change is significant since it indicates better overlap with fluorescence emission from a potential weakly fluorescent fluorophore.

The Sustained Release of Drugs, Pesticides, Insecticides and Fragrances and the development of a new generation of Heterogeneous catalysts.

The metal oxide films obtained by way of the present invention are suitable for adsorption of drug molecules in medical applications, the adsorption of catalysts for the generation of heterogeneous catalysis systems, adsorption of dyes for coloured coating applications and adsorption of fragrances for application in air fresheners.

With regard to the application of these coatings in the sustained release of drugs they can also be used for the timed release of drug cocktails by layering and sandwiching of individual drugs. Such technology is of particular importance in the area of stent implantation.

### Example 18

An Example whereby a drug is adsorbed onto the surface of tin(IV) oxide acetate is one whereby naproxen is adsorbed and FIG. 38 illustrates the infrared spectrum of the tin(IV) oxide acetate/naproxen derivative.

A typical example of the sustained drug release capacity of these coatings together with the capacity to sandwich drugs is one whereby stainless steel (18/8) coupons were coated with three layers of titanium (IV) oxide, annealed at 800° C. for two hours (after each coating) and subsequently coated and/or treated with paclitaxel (a drug administered to patients on implantation of a stent) under a variety of conditions details of which are given in Table 4. In this particular study a number of blanks or controls were used and these are as indicated in the table.

The drug treated samples prepared in the experiments outlined in Table 4 were subjected to drug elution studies under standard conditions. The uncoated stainless steel sample (control, experiment 6) eluted immediately any traces of drug that were present on the surface. Samples treated with the 50:50 drug as per experiments 3 and 5 were very successful with drug elution lasting in excess of 66 days at which point the elution studies were discontinued. The sample prepared as outlined in experiment 1 was a control sample and was used to check the porosity of the coatings. Other samples which were drug treated (experiments 2 and 4) had limited success in that they eluted over periods of 4 days to two weeks. The samples that were annealed at 270° C. (Experiments 7 & 8) proved unsuitable and the control sample here (experiment 9) indicated a sticky type surface on the steel coupon.

TABLE 4
Drug Treatment of Titanium (IV) Oxide Spin
Coated 18/8 stainless steel Coupons

| Experi- | |
|---|---|
| ment | |
| No. | Treatment |
| 1 | Three coatings of Titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 800° C. for two hours. This sample was not drug treated and |
| | held as a control sample. |
| 2 | Three coatings of titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 800° C. for two hours. This sample was soaked in a 1% |
| | solution of paclitaxel in ethanol for sixty hours at room |
| | temperature and then dried in the open air. |
| 3 | Three coatings of titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 800° C. for two hours. This sample was soaked in a 1% |
| | solution of paclitaxel in ethanol for sixty hours at room |
| | temperature and then dried in the open air. Subsequent to this |
| | it was coated with a 50:50 (w/w) solution of titanium (IV) |
| | oxide trifluoroacetate and paclitaxel in ethanol (0.5 g |
| | TiO2/TFA, 0.5 g Paclitaxel, 5 cm3 ethanol. |
| 4 | Three coatings of titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 800° C. for two hours. This sample was soaked in a 1% |
| | solution of paclitaxel in ethanol for sixty hours at room |
| | temperature and then dried in the open air. Subsequent to this |
| | it was further coated with titanium (IV) oxide using Titanium |
| | (IV) trifluoroacetate in butanone (100 g/L, 0.3 cm3 solution, 1st |
| | spin 500 rpm, 2nd spin 3000 rpm) and then heated to 70° C. for |
| | two hours |
| 5 | Three coatings of titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 800° C. for two hours. This sample was not soaked in 1% |
| | paclitaxel in ethanol but was coated directly with a 50:50 |
| | (w/w) paclitaxel:TiO2/TFA in butanone (0.5 g paclitaxel, |
| | 0.5 g TiO2/TFA in 5 cm3 butanone, 0.3 cm3 solution, 1st spin |
| | 500 rpm, 2nd spin 3000 rpm). This was then heated to 70° C. for |
| | two hours. |
| 6 | Uncoated 18/8 stainless steel coupon soaked in a 1% solution |
| | of paclitaxel in ethanol for sixty hours at room temperature |
| | and then dried in the open air. Control sample. |
| 7 | Three coatings of titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 270° C. for two hours. This sample was soaked in a 1% |
| | solution of paclitaxel in ethanol for twenty four hours at room |
| | temperature and then dried in the open air. |
| 8 | Three coatings of titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 270° C. for two hours. This sample was not soaked in 1% |
| | paclitaxel in ethanol but was coated directly with a 50:50 |
| | (w/w) paclitaxel:TiO2/TFA in butanone (0.5 g paclitaxel, |
| | 0.5 g TiO2/TFA in 5 cm3 butanone, 0.3 cm3 solution, 1st spin |
| | 500 rpm, 2nd spin 3000 rpm). This was then heated to 70° C. for |
| | two hours. |
| 9 | Three coatings of titanium (IV) oxide using Titanium (IV) |
| | trifluoroacetate in butanone (100 g/L, 0.3 cm3 per coating, 1st |
| | spin 500 rpm, 2nd spin 3000 rpm). Each coating was annealed |
| | at 270° C. for two hours. No drug treatment of any sort. Control |
| | sample. |

Also in the course of this work titanium(IV) oxide trifluoroacetate was reacted directly with paclitaxel in ethanol in a 1:1 w/w ratio and the surface derivatised titanium (IV) oxide/trifluoroacetate/paclitaxel material was isolated in the solid state and characterised using infrared spectroscopy. This CIP lays claim to this material.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described but may be varied in both construction and detail within the scope of the claims.

What is claimed is:

1. Surface modified soluble metal oxide crystallite particles comprising a plurality of metal and oxygen moieties having a sufficient number of carboxylate groups, from carboxylic acid used to modify the surface of the metal oxide, attached to the surface metal atoms so as to allow the surface modified metal oxide to be solubilised, wherein the carboxylic acid is selected from the group consisting of:
a cyclic C₁-C₂₀ aliphatic organic acid, an acyclic C₁-C₂₀ aliphatic organic acid, a C₆-C₂₀ aromatic organic acid, monocarboxylic acids, dicarboxylic acids, tricarboxylic acids, and combinations thereof;
wherein the acid is optionally substituted one or more times with one or more halogen atoms, one or more alkoxy groups, and one or more hydroxyl groups and combinations thereof.

2. The soluble metal oxide of claim 1 wherein the carboxylic acid is selected from the group consisting of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic-, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acid acetic, cyanoacetic, propanoic, tartaric, and citric acid and combinations thereof.

3. Surface modified soluble doped metal oxide crystallite particles comprising surface modified soluble metal oxide crystallite particles comprising a plurality of metal and oxygen moieties having a sufficient number of carboxylate groups, from carboxylic acid used to modify the surface of the metal oxide, attached to the surface metal atoms so as to allow the surface modified metal oxide to be solubilised, doped with at least one further metal, wherein the carboxylic acid is selected from the group consisting of:
a cyclic C₁-C₂₀ aliphatic organic acid, an acyclic C₁-C₂₀ aliphatic organic acid, a C₆-C₂₀ aromatic organic acid, monocarboxylic acids, dicarboxylic acids, tricarboxylic acids, and combinations thereof;
wherein the acid is optionally substituted one or more times with one or more halogen atoms, one or more alkoxy groups, and one or more hydroxyl groups and combinations thereof.

4. The soluble doped metal oxide of claim 3 wherein the carboxylic acid is selected from the group consisting of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acid acetic, cyanoacetic, propanoic, tartaric, and citric acid and combinations thereof.

5. The soluble doped metal oxide as claimed in claim 3 wherein the dopant metal is selected from the group comprising of tin, indium, antimony, zinc, titanium, vanadium, chromium, manganese, iron, ruthenium, osmium, tungsten, cobalt, nickel, zirconium, molybdenum, palladium, iridium, magnesium, and combinations thereof.

6. The soluble metal oxide of claim 1 including a solvent for use in the preparation of a solution, wherein the solvent of said solution is selected from the group consisting of one or more of tetrahydrofuran, dimethylformamide, dimethyl sulphoxide, ethyl acetate, amyl acetate, pyridine, water, acetophenone, isophorone, an alcohol having the general formula: 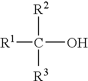
where R¹, R² and R³ represent one of:
R¹═R²═R³═H
R¹═R²═H; R³═(CH)nCH₃ (n=0, 1, 2, 3, 4, 5)
R¹═H; R²═R³═CH₃
R¹═H; R²═CH₃; R═CH2CH₃
R¹═R²═R³═CH₃
an ether having the general formula R¹—O—R²
where R¹ and R² represent one of:
R¹═R²═CH₂CH₃
R¹═CH₃; R²═CH₂CH₃
R¹═R²=(CH₂)₃CH₃; and
a ketone having the general formula R¹COR²
Where R¹=(CH2)ₙ CH₃ (n=0, 1, 2, 3, 4, 5)
R²═(CH₂)ₙ CH₃ (n=0, 1, 2, 3, 4, 5)
and R¹═R² or R1 ≠R².
a diketone having the general formula R¹COCH₂COR²
Where R¹═(CH₂)ₙ CH₃ (n=0, 1, 2, 3, 4, 5)
R²═(CH₂)ₙ CH₃ (n=0, 1, 2, 3, 4, 5)
and R¹═R¹ or R¹ ≠R².
a C₅-C₁₂ cyclic ketone optionally substituted with methyl groups and/or optionally unsaturated selected from the group of cyclopentanone, 2-methylcyclopentanone, 3-methylcyclopentanone, cyclohexanone, 2-methylcyclohexanone, 3-methylcyclohexanone, 4-methylcyclohexanone, 3,3,5-trimethylcyclohexanone, 3,5,5-trimethyl-2-cyclohexene-1-one (Isophorone), 2-cyclohexene-1-one, 3-methyl-2-cyclohexene-1-one, 3-methyl-5-heptene-2-one and combinations thereof.

7. The soluble doped metal oxide of claim 3 including a solvent for use in the preparation of a solution, wherein the solvent of said solution is selected from the group consisting of one or more of tetrahydrofuran, dimethylformamide, dimethyl sulphoxide, ethyl acetate, amyl acetate, pyridine, water, acetophenone, isophorone, an alcohol having the general formula: 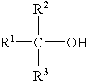
where R¹, R² and R³ represent one of:
R¹═R²═H; R³═(CH)ₙ CH₃ (n=0, 1, 2, 3, 4, 5)
R¹═R²═H; R³=³═CH₃
R¹H; R²═R³CH₃
R¹═H; R²═CH₃; R³═CH₂CH₃
R¹═R²═R³═CH₃
an ether having the general formula R′—O—R²
where R¹ and R² represent one of:
R¹═R²═CH₂CH₃
R¹═CH₃; R²═CH₂CH₃
R¹═R²═(CH₂)₃CH3; and
a ketone having the general formula R¹COR²
Where R¹═(CH2)ₙ CH₃ (n=0, 1, 2, 3, 4, 5)
R²═(CH₂)ₙ CH₃ (n=0, 1, 2, 3, 4, 5)
and R¹═R² or R¹≠R².
a diketone having the general formula R¹COCH₂COR²
Where R¹═(CH₂)ₙ CH₃ (n=0, 1, 2, 3, 4, 5)
R²=(CH₂)ₙ CH₃ (n=0, 1, 2, 3, 4, 5)
and R¹═R² or R¹ ≠R².
a C₅-C₁₂ cyclic ketone optionally substituted with methyl groups and/or optionally unsaturated selected from the group of cyclopentanone, 2-methylcyclopentanone, 3-methylcyclopentanone, cyclohexanone, 2-methylcyclohexanone, 3-methylcyclohexanone, 4-methylcyclohexanone, 3,3,5-trimethylcyclohexanone, 3,5,5-trimethyl-2-cyclohexene-1-one (Isophorone), 2-cyclohexene-1-one, 3-methyl-2-cyclohexene-1-one, 3-methyl-5-heptene-2-one and combinations thereof.

8. A coating applied to a substrate comprising:
surface modified soluble metal oxide crystallite particles, optionally doped with at least one further metal, comprising a plurality of metal and oxygen moieties having a sufficient number of carboxylate groups, from carboxylic acid used to modify the surface of the metal oxide, attached to the surface metal atoms so as to allow the surface modified metal oxide to be solubilised, wherein the carboxylic acid is selected from the group consisting of:
a cyclic C₁-C₂₀ aliphatic organic acid, an acyclic C₁-C₂₀ aliphatic organic acid, a C₆-C₂₀ aromatic organic acid, monocarboxylic acids, dicarboxylic acids, tricarboxylic acids, and combinations thereof;
wherein the acid is optionally substituted one or more times with one or more halogen atoms, one or more alkoxy groups, and one or more hydroxyl groups and combinations thereof.

9. The soluble metal oxide of claim 8 wherein the carboxylic acid is selected from the group consisting of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acid acetic, cyanoacetic, propanoic, tartaric, and citric acid and combinations thereof.

10. A coating as claimed in claim 8 with a roughness factor (Rₐ) of less than or equal to about 0.6 nm.

11. A coating as claimed in claim 8 with a Young's modulus of less than or equal to 66 Gpa.

12. A coating as claimed in claim 8 wherein delamination of the coating from a substrate on which it is coated occurs at a load of greater than about 6.0 mN.

13. A coating as claimed in claim 8 wherein the coating is porous and the pores in the porous coating are sized for adsorption of at least one of a chemical or biological agent.

14. A coating as claimed in claim 13 wherein adsorption of least one of a chemical or biological agent allows sustained release of the chemical or biological agent.

15. A coating as claimed in claim 13 wherein adsorption of at least one of chemical or biological agents allows retained adsorption of the molecule.

16. A coating as claimed in claim 8 wherein said coating is adapted for use as one of a coating for a pharmaceutical preparation, a coating for a medical device, or a coating for a device for implantation into the human or animal body.

17. A coating as claimed in claim 8, wherein said coating is adapted for application to said substrate as a friction reducing coating.

18. A coating as claimed in claim 8, wherein said coating is adapted for application to said substrate wherein said substrate has moving parts.

19. A coating as claimed in claim 8 wherein said coating is adapted for use to increase fluorescence emission in a fluorophore.

20. A coating as claimed in claim 8 wherein said coating is adapted for application to said substrate to form an electrically conductive pathway or impart a desired refractive index or colour to the substrate.

21. A coating as claimed in claim 8 wherein the substrate forms part of either an electronic device or an electrochromic device.

22. A catalytic composition adapted for use as a coating for a substrate, said catalytic composition comprising:
a surface modified soluble metal oxide crystallite particles comprising a plurality of metal and oxygen moieties having a sufficient number of carboxylate groups, from carboxylic acid used to modify the surface of the metal oxide, attached to the surface metal atoms so as to allow the surface modified metal oxide to be solubilised, wherein the carboxylic acid is selected from the group consisting of:
a cyclic C₁-C₂₀ aliphatic organic acid, an acyclic C₁-C₂₀ aliphatic organic acid, a C₆-C₂₀ aromatic organic acid, monocarboxylic acids, dicarboxylic acids, tricarboxylic acids, and combinations thereof;
wherein the acid is optionally substituted one or more times with one or more halogen atoms, one or more alkoxy groups, and one or more hydroxyl groups and combinations thereof,
wherein the soluble metal oxide is;
optionally doped with at least one further metal, optionally in solution,
or optionally doped with at least one further metal and in solution.

23. The catalytic composition of claim 22 wherein the carboxylic acid is selected from the group consisting of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic, malonic, and succinic acid acetic, cyanoacetic, propanoic, tartaric, and citric acid and combinations thereof.

24. A fire retardant composition adapted for use as a coating for a substrate, said fire retardant composition comprising
a surface modified soluble metal oxide crystallite particles, optionally doped with at least one further metal, comprising a plurality of metal and oxygen moieties having a sufficient number of carboxylate groups, from carboxylic acid used to modify the surface of the metal oxide, attached to the surface metal atoms so as to allow the surface modified metal oxide to be solubilised, wherein the carboxylic acid is selected from at least one of the group consisting of:
a cyclic C₁-C₂₀ aliphatic organic acid, an acyclic C₁-C₂₀ aliphatic organic acid, a C₆-C₂₀ aromatic organic acid, monocarboxylic acids, dicarboxylic acids, tricarboxylic acids, and combinations thereof;
wherein the acid is optionally substituted one or more times with one or more halogen atoms, one or more alkoxy groups, and one or more hydroxyl groups and combinations thereof.

25. The catalytic composition of claim 24 wherein the carboxylic acid is selected from the group consisting of monohaloacetic, fluoroacetic, chloroacetic, bromoacetic, iodoacetic, dihaloacetic, difluoroacetic, dichloroacetic, dibromoacetic, diiodoacetic, trihaloacetic, trifluoroacetic, trichloroacetic, tribromoacetic, triiodoacetic, mixed dihaloacetic, chlorofluoroacetic, bromofluoroacetic, iodofluoroacetic, bromochloroacetic, iodochloroacetic, iodobromoacetic, mixed trihaloacetic, chlorodifluoroacetic, bromodifluoroacetic iododifluoroacetic, fluorodichloroacetic, bromodichloroacetic, iododichloroacetic, fluorodibromoacetic, chlorodibromoacetic, iododibromoacetic, fluorodiiodoacetic, chlorodiiodoacetic, bromodiidoacetic, monoalkoxyacetic, dialkoxyacetic, trialkoxyacetic, methoxy acetic, ethoxy acetic, dimethoxy acetic, diethoxy acetic, triethoxy acetic, hydroxyacetic, dihydroxyacetic, monohalopropanoic, dihalopropanoic, trihalopropanoic, tetrahalopropanoic, pentahalopropanoic, mixed dihalopropanoic, mixed trihalopropanoic, mixed tetrahalopropanoic, mixed pentahalopropanoic, 2-hydroxypropanoic, 3-hydroxypropanoic, 2,3-dihydroxypropanoic, 2,2-dihydroxypropanoic, propenoic, oxalic,- malonic, and succinic acid acetic, cyanoacetic, propanoic, tartaric, and citric acid and combinations thereof.
